(19) United States
(12) Patent Application Publication
(10) Pub. No.: US 2017/0094288 A1
(43) Pub. Date: Mar. 30, 2017

(54) APPARATUS, A METHOD AND A COMPUTER PROGRAM FOR VIDEO CODING AND DECODING

(71) Applicant: Nokia Technologies Oy, Espoo (FI)

(72) Inventor: Miska Matias Hannuksela, Tampere (FI)

(21) Appl. No.: 14/866,702

(22) Filed: Sep. 25, 2015

(51) Int. Cl. H04N 19/187; H04N 19/146; H04N 19/105; H04N 19/109; H04N 19/159

(52) U.S. Cl. CPC H04N 19/187; H04N 19/109; H04N 19/159; H04N 19/105; H04N 19/146

(57) ABSTRACT

A method comprising encoding a first scalability layer comprising at least a first coded base picture and a second coded base picture, the first scalability layer being decodable using a first algorithm; reconstructing the first and second coded base pictures into a first and second reconstructed base pictures, respectively, the first reconstructed base picture and the second reconstructed base picture being adjacent in output order of the first algorithm among all reconstructed pictures of the first scalability layer; reconstructing, by using a second algorithm, a third reconstructed base picture from at least the first and second reconstructed base pictures, the third reconstructed base picture residing between the first reconstructed base picture and the second reconstructed base picture in output order; encoding a second scalability layer comprising at least a first coded enhancement picture, a second coded enhancement picture and a third coded enhancement picture, the second scalability layer being decodable using a third algorithm comprising inter-layer prediction that takes a reconstructed picture as input; and reconstructing the first, second, and third coded enhancement pictures into a first, second, and third reconstructed enhancement pictures, respectively, by giving the first, second, and third reconstructed base pictures, respectively, as input for inter-layer prediction, the first, second, and third reconstructed enhancement picture matching in output order of the first algorithm with the first, second, and third reconstructed base pictures, respectively.

### TECHNICAL FIELD

The present invention relates to an apparatus, a method and a computer program for video coding and decoding.

### BACKGROUND

There is an inevitable trend of increasing picture rates in consumer and professional video. In many applications, it is beneficial that the picture rate can be selected by the decoder or player according to its capabilities. For example, even if a bitstream providing 120-Hz picture rate is provided to the player, it could be beneficial that e.g. a 30-Hz version could be decoded if such better suits e.g. the available computational resources, the available battery charging level, and/or the display capabilities. Such scaling can be achieved by applying temporal scalability in video encoding and decoding.

The temporal scalability may involve a problem that video captured with short exposure times (e.g. for 240 Hz) may look unnatural when it is temporally subsampled to be played at 30 Hz due to the lacking motion blur. Temporal scalability and exposure time scaling may be involve a case, where the exposure time at the lower frame may be different than at the higher frame rate, which may result in a rather complex issue to handle.

A high-level-syntax-only (HLS-only) design principle was chosen for SHVC and MV-HEVC (Scalable and MultiView extensions to the High Efficiency Video Coding H.265/HEVC a.k.a. HEVC), meaning that there are no changes to the HEVC syntax or decoding process below the slice header. Consequently, the HEVC encoder and decoder implementations can be largely re-used for SHVC and MV-HEVC. For SHVC, a concept known as inter-layer processing is used, which is used to resample the decoded reference layer picture and its motion vector array, if needed, and/or to apply color mapping (e.g. for color gamut scaling). Similarly to inter-layer processing, picture rate upsampling (a.k.a. frame rate upsampling) methods are applied as post-processing to decoding.

Considering the HLS-only design of many contemporary video coding standards, there is a need to improve the compression efficiency of temporally scalable bitstreams in a manner that existing implementations (e.g. HEVC, SHVC) can be re-used.

### SUMMARY

Now in order to at least alleviate the above problems, an improved method for a video coding is introduced herein.

A first aspect comprises a method for encoding a bitstream comprising video signal, the method comprising

encoding a first scalability layer comprising at least a first coded base picture and a second coded base picture, the first scalability layer being decodable using a first algorithm;

reconstructing the first and second coded base pictures into a first and second reconstructed base pictures, respectively, the first reconstructed base picture and the second reconstructed base picture being adjacent in output order of the first algorithm among all reconstructed pictures of the first scalability layer;

reconstructing, by using a second algorithm, a third reconstructed base picture from at least the first and second reconstructed base pictures, the third reconstructed base picture residing between the first reconstructed base picture and the second reconstructed base picture in output order;

encoding a second scalability layer comprising at least a first coded enhancement picture, a second coded enhancement picture and a third coded enhancement picture, the second scalability layer being decodable using a third algorithm comprising inter-layer prediction that takes a reconstructed picture as input; and

reconstructing the first, second, and third coded enhancement pictures into a first, second, and third reconstructed enhancement pictures, respectively, by giving the first, second, and third reconstructed base pictures, respectively, as input for inter-layer prediction, the first, second, and third reconstructed enhancement picture matching in output order of the first algorithm with the first, second, and third reconstructed base pictures, respectively.

According to an embodiment, the method further comprises:

indicating that the first coded base picture and the second coded base picture conform to a first profile;

indicating a second profile that is required to reconstruct the third reconstructed base picture;

indicating that the first coded enhancement picture, the second coded enhancement picture, and the third coded enhancement picture conform to a third profile;

wherein the first profile, the second profile, and the third profile differ from each other and the first profile is indicative of the first algorithm; the second profile is indicative of the second algorithm, and the third profile is indicative of the third algorithm.

According to an embodiment, the picture rate is increased without enhancing the base pictures in the first scalability layer, the method further comprising at least one of the following:
encoding the second scalability layer in a manner that the pictures corresponding to the pictures of the first scalability layer are skip coded;
encoding the second scalability layer in a manner that no pictures are encoded corresponding to the pictures of the first scalability layer.

According to an embodiment, the method further comprising at least one of the following:
reconstructing the third reconstructed base picture from at least the first and second reconstructed base pictures prior to their modification; and modifying the first, second and third reconstructed base pictures by using the corresponding pictures of the second enhancement layer;
modifying the first and second reconstructed base pictures, and using the modified first and second base pictures as input to reconstruct the third reconstructed base picture;
modifying the first and second reconstructed base pictures by using the corresponding pictures of the second enhancement layer, and using the reconstructed pictures of the second enhancement layer as input to reconstruct the third reconstructed base picture.

According to an embodiment, the picture rate is increased and at least one type of enhancement is applied to the base pictures of the first scalability layer, the enhancement comprising at least one of the following: signal-to-noise enhancement, spatial enhancement, sample bit-depth increase, dynamic range increase, or broadening the color gamut.

A second aspect relates to an apparatus comprising:

at least one processor and at least one memory, said at least one memory stored with code thereon, which when executed by said at least one processor, causes an apparatus to perform at least

encoding a first scalability layer comprising at least a first coded base picture and a second coded base picture, the first scalability layer being decodable using a first algorithm;

reconstructing the first and second coded base pictures into a first and second reconstructed base pictures, respectively, the first reconstructed base picture and the second reconstructed base picture being adjacent in output order of the first algorithm among all reconstructed pictures of the first scalability layer;

reconstructing, by using a second algorithm, a third reconstructed base picture from at least the first and second reconstructed base pictures, the third reconstructed base picture residing between the first reconstructed base picture and the second reconstructed base picture in output order;

encoding a second scalability layer comprising at least a first coded enhancement picture, a second coded enhancement picture and a third coded enhancement picture, the second scalability layer being decodable using a third algorithm comprising inter-layer prediction that takes a reconstructed picture as input; and

reconstructing the first, second, and third coded enhancement pictures into a first, second, and third reconstructed enhancement pictures, respectively, by giving the first, second, and third reconstructed base pictures, respectively, as input for inter-layer prediction, the first, second, and third reconstructed enhancement picture matching in output order of the first algorithm with the first, second, and third reconstructed base pictures, respectively.

A third aspect relates to a computer readable storage medium stored with code thereon for use by an apparatus, which when executed by a processor, causes the apparatus to perform the above operations.

A fourth aspect comprises a method comprising:

decoding, using a first algorithm, a first and a second coded base pictures into a first and a second reconstructed base pictures, respectively, the first and second coded base pictures being comprised in a first scalability layer and the first reconstructed base picture and the second reconstructed base picture being adjacent in output order of the first algorithm among all reconstructed pictures of the first scalability layer;

reconstructing, by using a second algorithm, a third reconstructed base picture from at least the first and second reconstructed base pictures, the third reconstructed base picture residing between the first reconstructed base picture and the second reconstructed base picture in output order; and

decoding, using a third algorithm, a first, a second, and a third coded enhancement pictures into a first, a second, and a third reconstructed enhancement pictures, respectively, by giving the first, second, and third reconstructed base pictures, respectively, as input for inter-layer prediction, the third algorithm comprising inter-layer prediction that takes a reconstructed picture as input, the first, second, and third reconstructed enhancement picture matching in output order of the first algorithm with the first, second, and third reconstructed base pictures, respectively, and the first, second and third coded enhancement pictures being comprised in a second scalability layer.

According to an embodiment, the method further comprises:

decoding a first indication that the first coded base picture and the second coded base picture conform to a first profile;

decoding a second indication of a second profile that is required to reconstruct the third reconstructed base picture;

decoding a third indication that the first coded enhancement picture, the second coded enhancement picture, and the third coded enhancement picture conform to a third profile;

wherein the first profile, the second profile, and the third profile differ from each other and the first profile is indicative of the first algorithm; the second profile is indicative of the second algorithm, and the third profile is indicative of the third algorithm; and

determining on the decoding of the first and second coded base pictures on the basis of supporting the first profile in decoding;

determining on the reconstructing of the third reconstructed base pictures on the basis of supporting the second profile in reconstructing and the first profile in decoding;

determining on the decoding of the first and second coded enhancement pictures on the basis of supporting the first and third profiles in decoding; and

determining on the decoding of the third enhancement picture on the basis of supporting the first and third profiles in decoding and the second profile in reconstructing.

According to an embodiment, the picture rate is increased without enhancing the base pictures in the first scalability layer, the method further comprising at least one of the following:
decoding an indication associated with the second scalability layer indicating that the pictures corresponding to the pictures of the first scalability layer are skip coded;
decoding the second scalability layer in a manner that no pictures are decoded corresponding to the pictures of the first scalability layer.

According to an embodiment, the method further comprises at least one of the following:
reconstructing the third reconstructed base picture from at least the first and second reconstructed base pictures prior to their modification; and modifying the first, second and third reconstructed base pictures by using the corresponding pictures of the second enhancement layer;
modifying the first and second reconstructed base pictures, and using the modified first and second base pictures as input to reconstruct the third reconstructed base picture;
modifying the first and second reconstructed base pictures by using the corresponding pictures of the second enhancement layer, and using the reconstructed pictures of the second enhancement layer as input to reconstruct the third reconstructed base picture.

According to an embodiment, the picture rate is increased and at least one type of enhancement is applied to the base pictures of the first scalability layer, the enhancement comprising at least one of the following: signal-to-noise enhancement, spatial enhancement, sample bit-depth increase, dynamic range increase, or broadening the color gamut.

A fifth aspect relates to an apparatus comprising:

at least one processor and at least one memory, said at least one memory stored with code thereon, which when executed by said at least one processor, causes an apparatus to perform at least

decoding, using a first algorithm, a first and a second coded base pictures into a first and a second reconstructed base pictures, respectively, the first and second coded base pictures being comprised in a first scalability layer and the first reconstructed base picture and the second reconstructed base picture being adjacent in output order of the first algorithm among all reconstructed pictures of the first scalability layer;

reconstructing, by using a second algorithm, a third reconstructed base picture from at least the first and second reconstructed base pictures, the third reconstructed base picture residing between the first reconstructed base picture and the second reconstructed base picture in output order; and

decoding, using a third algorithm, a first, a second, and a third coded enhancement pictures into a first, a second, and a third reconstructed enhancement pictures, respectively, by giving the first, second, and third reconstructed base pictures, respectively, as input for inter-layer prediction, the third algorithm comprising inter-layer prediction that takes a reconstructed picture as input, the first, second, and third reconstructed enhancement picture matching in output order of the first algorithm with the first, second, and third reconstructed base pictures, respectively, and the first, second and third coded enhancement pictures being comprised in a second scalability layer.

A sixth aspect relates to a computer readable storage medium stored with code thereon for use by an apparatus, which when executed by a processor, causes the apparatus to perform the above operations.

These and other aspects of the invention and the embodiments related thereto will become apparent in view of the detailed disclosure of the embodiments further below.

### BRIEF DESCRIPTION OF THE DRAWINGS

For better understanding of the present invention, reference will now be made by way of example to the accompanying drawings in which:

FIG. 1 shows schematically an electronic device employing embodiments of the invention;

FIG. 2 shows schematically a user equipment suitable for employing embodiments of the invention;

FIG. 3 further shows schematically electronic devices employing embodiments of the invention connected using wireless and wired network connections;

FIG. 4 shows schematically an encoder suitable for implementing embodiments of the invention;

FIG. 5 shows a flow chart of an encoding method according to an embodiment of the invention;

FIG. 6 shows a general level illustration of encoding principles according to an embodiment of the invention;

FIG. 7 shows an encoding method with skip coded pictures according to an embodiment of the invention;

FIG. 8 shows an encoding method with coding no pictures in the second scalability layer according to an embodiment of the invention;

FIG. 9 shows an encoding method with modifying of reconstructed base pictures according to an embodiment of the invention;

FIG. 10 shows an encoding method with modified base pictures used for inter-layer prediction and picture rate upsampling according to another embodiment of the invention;

FIG. 11 shows an encoding method according to another embodiment of the invention;

FIG. 12 shows an encoding method according to yet another embodiment of the invention;

FIG. 13 shows an encoding method according to yet another embodiment of the invention;

FIG. 14 shows an encoding method according to yet another embodiment of the invention;

FIG. 15 shows an encoding method according to yet another embodiment of the invention;

FIG. 16 shows schematically a decoder suitable for implementing embodiments of the invention; and

FIG. 17 shows a schematic diagram of an example multimedia communication system within which various embodiments may be implemented.

### DETAILED DESCRIPTION OF SOME EXAMPLE EMBODIMENTS

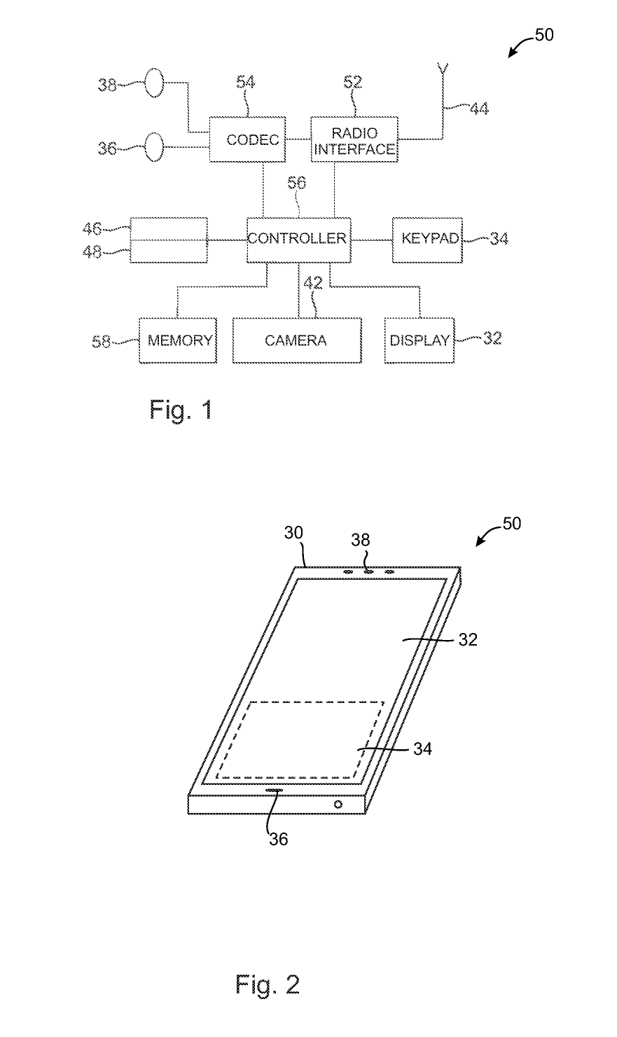

The following describes in further detail suitable apparatus and possible mechanisms for motion compensated prediction. In this regard reference is first made to FIGS. 1 and 2, where FIG. 1 shows a block diagram of a video coding system according to an example embodiment as a schematic block diagram of an exemplary apparatus or electronic device 50, which may incorporate a codec according to an embodiment of the invention. FIG. 2 shows a layout of an apparatus according to an example embodiment. The elements of FIGS. 1 and 2 will be explained next.

The electronic device 50 may for example be a mobile terminal or user equipment of a wireless communication system. However, it would be appreciated that embodiments of the invention may be implemented within any electronic device or apparatus which may require encoding and decoding or encoding or decoding video images.

The apparatus 50 may comprise a housing 30 for incorporating and protecting the device. The apparatus 50 further may comprise a display 32 in the form of a liquid crystal display. In other embodiments of the invention the display may be any suitable display technology suitable to display an image or video. The apparatus 50 may further comprise a keypad 34. In other embodiments of the invention any suitable data or user interface mechanism may be employed. For example the user interface may be implemented as a virtual keyboard or data entry system as part of a touch-sensitive display.

The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 may also comprise a battery 40 (or in other embodiments of the invention the device may be powered by any suitable mobile energy device such as solar cell, fuel cell or clockwork generator). The apparatus may further comprise a camera 42 capable of recording or capturing images and/or video. The apparatus 50 may further comprise an infrared port for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56 or processor for controlling the apparatus 50. The controller 56 may be connected to memory 58 which in embodiments of the invention may store both data in the form of image and audio data and/or may also store instructions for implementation on the controller 56. The controller 56 may further be connected to codec circuitry 54 suitable for carrying out coding and decoding of audio and/or video data or assisting in coding and decoding carried out by the controller.

The apparatus 50 may further comprise a card reader 48 and a smart card 46, for example a UICC and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es).

The apparatus 50 may comprise a camera capable of recording or detecting individual frames which are then passed to the codec 54 or the controller for processing. The apparatus may receive the video image data for processing from another device prior to transmission and/or storage. The apparatus 50 may also receive either wirelessly or by a wired connection the image for coding/decoding.

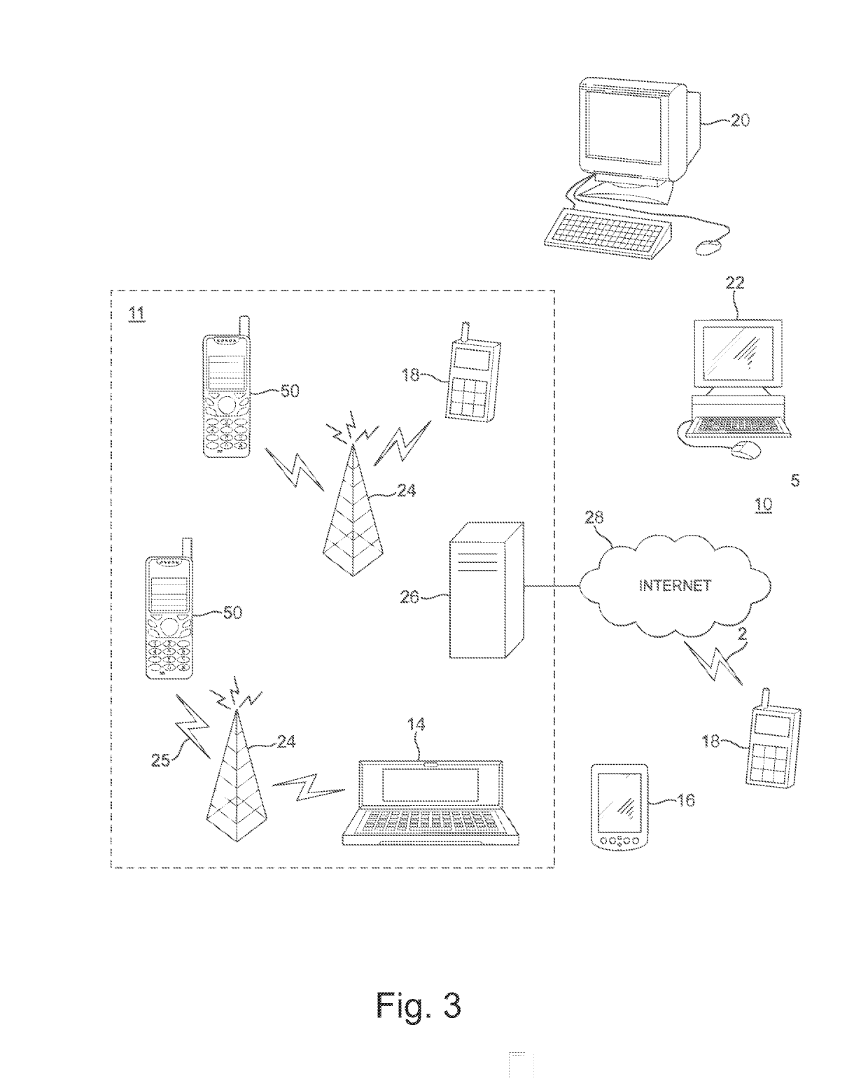

With respect to FIG. 3, an example of a system within which embodiments of the present invention can be utilized is shown. The system 10 comprises multiple communication devices which can communicate through one or more networks. The system 10 may comprise any combination of wired or wireless networks including, but not limited to a wireless cellular telephone network (such as a GSM, UMTS, CDMA network etc), a wireless local area network (WLAN) such as defined by any of the IEEE 802.x standards, a Bluetooth personal area network, an Ethernet local area network, a token ring local area network, a wide area network, and the Internet.

The system 10 may include both wired and wireless communication devices and/or apparatus 50 suitable for implementing embodiments of the invention.

For example, the system shown in FIG. 3 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

The embodiments may also be implemented in a set-top box; i.e. a digital TV receiver, which may/may not have a display or wireless capabilities, in tablets or (laptop) personal computers (PC), which have hardware or software or combination of the encoder/decoder implementations, in various operating systems, and in chipsets, processors, DSPs and/or embedded systems offering hardware/software based coding.

Some or further apparatus may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11 and any similar wireless communication technology. A communications device involved in implementing various embodiments of the present invention may communicate using various media including, but not limited to, radio, infrared, laser, cable connections, and any suitable connection.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, from one or several senders (or transmitters) to one or several receivers.

Real-time Transport Protocol (RTP) is widely used for real-time transport of timed media such as audio and video. RTP may operate on top of the User Datagram Protocol (UDP), which in turn may operate on top of the Internet Protocol (IP). RTP is specified in Internet Engineering Task Force (IETF) Request for Comments (RFC) 3550, available from www.ietf.org/rfc/rfc3550.txt. In RTP transport, media data is encapsulated into RTP packets. Typically, each media type or media coding format has a dedicated RTP payload format.

An RTP session is an association among a group of participants communicating with RTP. It is a group communications channel which can potentially carry a number of RTP streams. An RTP stream is a stream of RTP packets comprising media data. An RTP stream is identified by an SSRC belonging to a particular RTP session. SSRC refers to either a synchronization source or a synchronization source identifier that is the 32-bit SSRC field in the RTP packet header. A synchronization source is characterized in that all packets from the synchronization source form part of the same timing and sequence number space, so a receiver may group packets by synchronization source for playback. Examples of synchronization sources include the sender of a stream of packets derived from a signal source such as a microphone or a camera, or an RTP mixer. Each RTP stream is identified by a SSRC that is unique within the RTP session. An RTP stream may be regarded as a logical channel.

Available media file format standards include ISO base media file format (ISO/IEC 14496-12, which may be abbreviated ISOBMFF), MPEG-4 file format (ISO/IEC 14496-14, also known as the MP4 format), file format for NAL unit structured video (ISO/IEC 14496-15) and 3GPP file format (3GPP TS 26.244, also known as the 3GP format). The ISO file format is the base for derivation of all the above mentioned file formats (excluding the ISO file format itself). These file formats (including the ISO file format itself) are generally called the ISO family of file formats.

Video codec consists of an encoder that transforms the input video into a compressed representation suited for storage/transmission and a decoder that can decompress the compressed video representation back into a viewable form. A video encoder and/or a video decoder may also be separate from each other, i.e. need not form a codec. Typically an encoder discards some information in the original video sequence in order to represent the video in a more compact form (that is, “lossy” compression, resulting in a lower bitrate). A video encoder may be used to encode an image sequence, as defined subsequently, and a video decoder may be used to decode a coded image sequence. A video encoder or an intra coding part of a video encoder or an image encoder may be used to encode an image, and a video decoder or an inter decoding part of a video decoder or an image decoder may be used to decode a coded image.

Typical hybrid video encoders, for example many encoder implementations of ITU-T H.263 and H.264, encode the video information in two phases. Firstly pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly the prediction error, i.e. the difference between the predicted block of pixels and the original block of pixels, is coded. This is typically done by transforming the difference in pixel values using a specified transform (e.g. Discrete Cosine Transform (DCT) or a variant of it), quantizing the coefficients and entropy coding the quantized coefficients. By varying the fidelity of the quantization process, the encoder can control the balance between the accuracy of the pixel representation (picture quality) and size of the resulting coded video representation (file size or transmission bitrate).

Inter prediction, which may also be referred to as temporal prediction, motion compensation, or motion-compensated prediction, reduces temporal redundancy. In inter prediction the sources of prediction are previously decoded pictures. Intra prediction utilizes the fact that adjacent pixels within the same picture are likely to be correlated. Intra prediction can be performed in the spatial or transform domain, i.e., either sample values or transform coefficients can be predicted. Intra prediction is typically exploited in intra coding, where no inter prediction is applied.

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

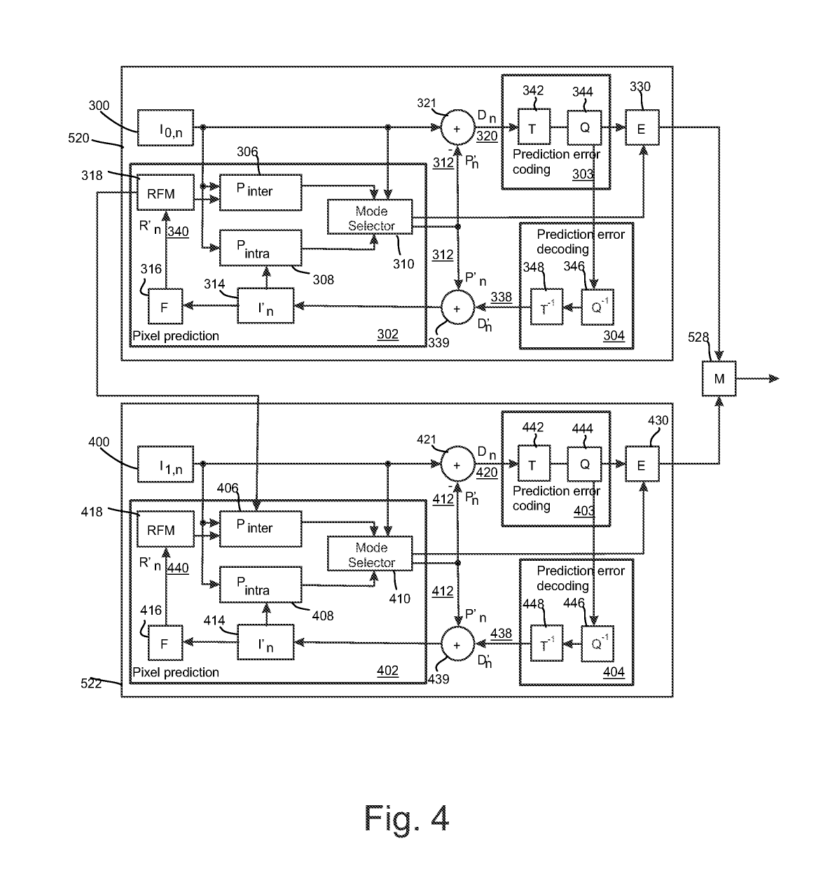

FIG. 4 shows a block diagram of a video encoder suitable for employing embodiments of the invention. FIG. 4 presents an encoder for two layers, but it would be appreciated that presented encoder could be similarly simplified to encode only one layer or extended to encode more than two layers. FIG. 4 illustrates an embodiment of a video encoder comprising a first encoder section 520 for a base layer and a second encoder section 522 for an enhancement layer. Each of the first encoder section 520 and the second encoder section 522 may comprise similar elements for encoding incoming pictures. The encoder sections 520, 522 may comprise a pixel predictor 302, 402, prediction error encoder 303, 403 and prediction error decoder 304, 404. FIG. 4 also shows an embodiment of the pixel predictor 302, 402 as comprising an inter-predictor 306, 406, an intra-predictor 308, 408, a mode selector 310, 410, a filter 316, 416, and a reference frame memory 318, 418. The pixel predictor 302 of the first encoder section 500 receives 300 base layer images of a video stream to be encoded at both the inter-predictor 306 (which determines the difference between the image and a motion compensated reference frame 318) and the intra-predictor 308 (which determines a prediction for an image block based only on the already processed parts of current frame or picture). The output of both the inter-predictor and the intra-predictor are passed to the mode selector 310. The intra-predictor 308 may have more than one intra-prediction modes. Hence, each mode may perform the intra-prediction and provide the predicted signal to the mode selector 310. The mode selector 310 also receives a copy of the base layer picture 300. Correspondingly, the pixel predictor 402 of the second encoder section 522 receives 400 enhancement layer images of a video stream to be encoded at both the inter-predictor 406 (which determines the difference between the image and a motion compensated reference frame 418) and the intra-predictor 408 (which determines a prediction for an image block based only on the already processed parts of current frame or picture). The output of both the inter-predictor and the intra-predictor are passed to the mode selector 410. The intra-predictor 408 may have more than one intra-prediction modes. Hence, each mode may perform the intra-prediction and provide the predicted signal to the mode selector 410. The mode selector 410 also receives a copy of the enhancement layer picture 400.

Depending on which encoding mode is selected to encode the current block, the output of the inter-predictor 306, 406 or the output of one of the optional intra-predictor modes or the output of a surface encoder within the mode selector is passed to the output of the mode selector 310, 410. The output of the mode selector is passed to a first summing device 321, 421. The first summing device may subtract the output of the pixel predictor 302, 402 from the base layer picture 300/enhancement layer picture 400 to produce a first prediction error signal 320, 420 which is input to the prediction error encoder 303, 403.

The pixel predictor 302, 402 further receives from a preliminary reconstructor 339, 439 the combination of the prediction representation of the image block 312, 412 and the output 338, 438 of the prediction error decoder 304, 404. The preliminary reconstructed image 314, 414 may be passed to the intra-predictor 308, 408 and to a filter 316, 416. The filter 316, 416 receiving the preliminary representation may filter the preliminary representation and output a final reconstructed image 340, 440 which may be saved in a reference frame memory 318, 418. The reference frame memory 318 may be connected to the inter-predictor 306 to be used as the reference image against which a future base layer picture 300 is compared in inter-prediction operations. Subject to the base layer being selected and indicated to be source for inter-layer sample prediction and/or inter-layer motion information prediction of the enhancement layer according to some embodiments, the reference frame memory 318 may also be connected to the inter-predictor 406 to be used as the reference image against which a future enhancement layer pictures 400 is compared in inter-prediction operations. Moreover, the reference frame memory 418 may be connected to the inter-predictor 406 to be used as the reference image against which a future enhancement layer picture 400 is compared in inter-prediction operations.

Filtering parameters from the filter 316 of the first encoder section 550 may be provided to the second encoder section 522 subject to the base layer being selected and indicated to be source for predicting the filtering parameters of the enhancement layer according to some embodiments.

The prediction error encoder 303, 403 comprises a transform unit 342, 442 and a quantizer 344, 444. The transform unit 342, 442 transforms the first prediction error signal 320, 420 to a transform domain. The transform is, for example, the DCT transform. The quantizer 344, 444 quantizes the transform domain signal, e.g. the DCT coefficients, to form quantized coefficients.

The prediction error decoder 304, 404 receives the output from the prediction error encoder 303, 403 and performs the opposite processes of the prediction error encoder 303, 403 to produce a decoded prediction error signal 338, 438 which, when combined with the prediction representation of the image block 312, 412 at the second summing device 339, 439, produces the preliminary reconstructed image 314, 414. The prediction error decoder may be considered to comprise a dequantizer 361, 461, which dequantizes the quantized coefficient values, e.g. DCT coefficients, to reconstruct the transform signal and an inverse transformation unit 363, 463, which performs the inverse transformation to the reconstructed transform signal wherein the output of the inverse transformation unit 363, 463 contains reconstructed block(s). The prediction error decoder may also comprise a block filter which may filter the reconstructed block(s) according to further decoded information and filter parameters.

The entropy encoder 330, 430 receives the output of the prediction error encoder 303, 403 and may perform a suitable entropy encoding/variable length encoding on the signal to provide error detection and correction capability. The outputs of the entropy encoders 330, 430 may be inserted into a bitstream e.g. by a multiplexer 528.

The H.264/AVC standard was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organisation for Standardization (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). There have been multiple versions of the H.264/AVC standard, integrating new extensions or features to the specification. These extensions include Scalable Video Coding (SVC) and Multiview Video Coding (MVC).

Version 1 of the High Efficiency Video Coding (H.265/HEVC a.k.a. HEVC) standard was developed by the Joint Collaborative Team—Video Coding (JCT-VC) of VCEG and MPEG. The standard was published by both parent standardization organizations, and it is referred to as ITU-T Recommendation H.265 and ISO/IEC International Standard 23008-2, also known as MPEG-H Part 2 High Efficiency Video Coding (HEVC). Version 2 of H.265/HEVC included scalable, multiview, and fidelity range extensions, which may be abbreviated SHVC, MV-HEVC, and REXT, respectively. Version 2 of H.265/HEVC was pre-published as ITU-T Recommendation H.265 (10/2014) and is likely to be published as Edition 2 of ISO/IEC 23008-2 in 2015. There are currently ongoing standardization projects to develop further extensions to H.265/HEVC, including three-dimensional and screen content coding extensions, which may be abbreviated 3D-HEVC and SCC, respectively.

SHVC, MV-HEVC, and 3D-HEVC use a common basis specification, specified in Annex F of the version 2 of the HEVC standard. This common basis comprises for example high-level syntax and semantics e.g. specifying some of the characteristics of the layers of the bitstream, such as inter-layer dependencies, as well as decoding processes, such as reference picture list construction including inter-layer reference pictures and picture order count derivation for multi-layer bitstream. Annex F may also be used in potential subsequent multi-layer extensions of HEVC. It is to be understood that even though a video encoder, a video decoder, encoding methods, decoding methods, bitstream structures, and/or embodiments may be described in the following with reference to specific extensions, such as SHVC and/or MV-HEVC, they are generally applicable to any multi-layer extensions of HEVC, and even more generally to any multi-layer video coding scheme.

Some key definitions, bitstream and coding structures, and concepts of H.264/AVC and HEVC are described in this section as an example of a video encoder, decoder, encoding method, decoding method, and a bitstream structure, wherein the embodiments may be implemented. Some of the key definitions, bitstream and coding structures, and concepts of H.264/AVC are the same as in HEVC—hence, they are described below jointly. The aspects of the invention are not limited to H.264/AVC or HEVC, but rather the description is given for one possible basis on top of which the invention may be partly or fully realized.

Similarly to many earlier video coding standards, the bitstream syntax and semantics as well as the decoding process for error-free bitstreams are specified in H.264/AVC and HEVC. The encoding process is not specified, but encoders must generate conforming bitstreams. Bitstream and decoder conformance can be verified with the Hypothetical Reference Decoder (HRD). The standards contain coding tools that help in coping with transmission errors and losses, but the use of the tools in encoding is optional and no decoding process has been specified for erroneous bitstreams.

In the description of existing standards as well as in the description of example embodiments, a syntax element may be defined as an element of data represented in the bitstream. A syntax structure may be defined as zero or more syntax elements present together in the bitstream in a specified order. In the description of existing standards as well as in the description of example embodiments, a phrase “by external means” or “through external means” may be used. For example, an entity, such as a syntax structure or a value of a variable used in the decoding process, may be provided “by external means” to the decoding process. The phrase “by external means” may indicate that the entity is not included in the bitstream created by the encoder, but rather conveyed externally from the bitstream for example using a control protocol. It may alternatively or additionally mean that the entity is not created by the encoder, but may be created for example in the player or decoding control logic or alike that is using the decoder. The decoder may have an interface for inputting the external means, such as variable values.

The elementary unit for the input to an H.264/AVC or HEVC encoder and the output of an H.264/AVC or HEVC decoder, respectively, is a picture. A picture given as an input to an encoder may also referred to as a source picture, and a picture decoded by a decoded may be referred to as a decoded picture.

The source and decoded pictures are each comprised of one or more sample arrays, such as one of the following sets of sample arrays:
Luma (Y) only (monochrome).
Luma and two chroma (YCbCr or YCgCo).
Green, Blue and Red (GBR, also known as RGB).
Arrays representing other unspecified monochrome or tri-stimulus color samplings (for example, YZX, also known as XYZ).

In the following, these arrays may be referred to as luma (or L or Y) and chroma, where the two chroma arrays may be referred to as Cb and Cr; regardless of the actual color representation method in use. The actual color representation method in use can be indicated e.g. in a coded bitstream e.g. using the Video Usability Information (VUI) syntax of H.264/AVC and/or HEVC. A component may be defined as an array or single sample from one of the three sample arrays arrays (luma and two chroma) or the array or a single sample of the array that compose a picture in monochrome format.

In H.264/AVC and HEVC, a picture may either be a frame or a field. A frame comprises a matrix of luma samples and possibly the corresponding chroma samples. A field is a set of alternate sample rows of a frame and may be used as encoder input, when the source signal is interlaced. Chroma sample arrays may be absent (and hence monochrome sampling may be in use) or chroma sample arrays may be subsampled when compared to luma sample arrays. Chroma formats may be summarized as follows:
In monochrome sampling there is only one sample array, which may be nominally considered the luma array.
In 4:2:0 sampling, each of the two chroma arrays has half the height and half the width of the luma array.
In 4:2:2 sampling, each of the two chroma arrays has the same height and half the width of the luma array.
In 4:4:4 sampling when no separate color planes are in use, each of the two chroma arrays has the same height and width as the luma array.

In H.264/AVC and HEVC, it is possible to code sample arrays as separate color planes into the bitstream and respectively decode separately coded color planes from the bitstream. When separate color planes are in use, each one of them is separately processed (by the encoder and/or the decoder) as a picture with monochrome sampling.

A partitioning may be defined as a division of a set into subsets such that each element of the set is in exactly one of the subsets.

In H.264/AVC, a macroblock is a 16×16 block of luma samples and the corresponding blocks of chroma samples. For example, in the 4:2:0 sampling pattern, a macroblock contains one 8×8 block of chroma samples per each chroma component. In H.264/AVC, a picture is partitioned to one or more slice groups, and a slice group contains one or more slices. In H.264/AVC, a slice consists of an integer number of macroblocks ordered consecutively in the raster scan within a particular slice group.

When describing the operation of HEVC encoding and/or decoding, the following terms may be used. A coding block may be defined as an N×N block of samples for some value of N such that the division of a coding tree block into coding blocks is a partitioning. A coding tree block (CTB) may be defined as an N×N block of samples for some value of N such that the division of a component into coding tree blocks is a partitioning. A coding tree unit (CTU) may be defined as a coding tree block of luma samples, two corresponding coding tree blocks of chroma samples of a picture that has three sample arrays, or a coding tree block of samples of a monochrome picture or a picture that is coded using three separate color planes and syntax structures used to code the samples. A coding unit (CU) may be defined as a coding block of luma samples, two corresponding coding blocks of chroma samples of a picture that has three sample arrays, or a coding block of samples of a monochrome picture or a picture that is coded using three separate color planes and syntax structures used to code the samples.

In some video codecs, such as High Efficiency Video Coding (HEVC) codec, video pictures are divided into coding units (CU) covering the area of the picture. A CU consists of one or more prediction units (PU) defining the prediction process for the samples within the CU and one or more transform units (TU) defining the prediction error coding process for the samples in the said CU. Typically, a CU consists of a square block of samples with a size selectable from a predefined set of possible CU sizes. A CU with the maximum allowed size may be named as LCU (largest coding unit) or coding tree unit (CTU) and the video picture is divided into non-overlapping LCUs. An LCU can be further split into a combination of smaller CUs, e.g. by recursively splitting the LCU and resultant CUs. Each resulting CU typically has at least one PU and at least one TU associated with it. Each PU and TU can be further split into smaller PUs and TUs in order to increase granularity of the prediction and prediction error coding processes, respectively. Each PU has prediction information associated with it defining what kind of a prediction is to be applied for the pixels within that PU (e.g. motion vector information for inter predicted PUs and intra prediction directionality information for intra predicted PUs).

The decoder reconstructs the output video by applying prediction means similar to the encoder to form a predicted representation of the pixel blocks (using the motion or spatial information created by the encoder and stored in the compressed representation) and prediction error decoding (inverse operation of the prediction error coding recovering the quantized prediction error signal in spatial pixel domain). After applying prediction and prediction error decoding means the decoder sums up the prediction and prediction error signals (pixel values) to form the output video frame. The decoder (and encoder) can also apply additional filtering means to improve the quality of the output video before passing it for display and/or storing it as prediction reference for the forthcoming frames in the video sequence.

The filtering may for example include one more of the following: deblocking, sample adaptive offset (SAO), and/or adaptive loop filtering (ALF). H.264/AVC includes a deblocking, whereas HEVC includes both deblocking and SAO.

In typical video codecs the motion information is indicated with motion vectors associated with each motion compensated image block, such as a prediction unit. Each of these motion vectors represents the displacement of the image block in the picture to be coded (in the encoder side) or decoded (in the decoder side) and the prediction source block in one of the previously coded or decoded pictures. In order to represent motion vectors efficiently those are typically coded differentially with respect to block specific predicted motion vectors. In typical video codecs the predicted motion vectors are created in a predefined way, for example calculating the median of the encoded or decoded motion vectors of the adjacent blocks. Another way to create motion vector predictions is to generate a list of candidate predictions from adjacent blocks and/or co-located blocks in temporal reference pictures and signalling the chosen candidate as the motion vector predictor. In addition to predicting the motion vector values, it can be predicted which reference picture(s) are used for motion-compensated prediction and this prediction information may be represented for example by a reference index of previously coded/decoded picture. The reference index is typically predicted from adjacent blocks and/or co-located blocks in temporal reference picture. Moreover, typical high efficiency video codecs employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information is carried out using the motion field information of adjacent blocks and/or co-located blocks in temporal reference pictures and the used motion field information is signalled among a list of motion field candidate list filled with motion field information of available adjacent/co-located blocks.

Typical video codecs enable the use of uni-prediction, where a single prediction block is used for a block being (de)coded, and bi-prediction, where two prediction blocks are combined to form the prediction for a block being (de)coded. Some video codecs enable weighted prediction, where the sample values of the prediction blocks are weighted prior to adding residual information. For example, multiplicative weighting factor and an additive offset which can be applied. In explicit weighted prediction, enabled by some video codecs, a weighting factor and offset may be coded for example in the slice header for each allowable reference picture index. In implicit weighted prediction, enabled by some video codecs, the weighting factors and/or offsets are not coded but are derived e.g. based on the relative picture order count (POC) distances of the reference pictures.

In typical video codecs the prediction residual after motion compensation is first transformed with a transform kernel (like DCT) and then coded. The reason for this is that often there still exists some correlation among the residual and transform can in many cases help reduce this correlation and provide more efficient coding.

Typical video encoders utilize Lagrangian cost functions to find optimal coding modes, e.g. the desired Macroblock mode and associated motion vectors. This kind of cost function uses a weighting factor 2 to tie together the (exact or estimated) image distortion due to lossy coding methods and the (exact or estimated) amount of information that is required to represent the pixel values in an image area:

C=D+λR, (1)

where C is the Lagrangian cost to be minimized, D is the image distortion (e.g. Mean Squared Error) with the mode and motion vectors considered, and R the number of bits needed to represent the required data to reconstruct the image block in the decoder (including the amount of data to represent the candidate motion vectors).

Video coding standards and specifications may allow encoders to divide a coded picture to coded slices or alike. In-picture prediction is typically disabled across slice boundaries. Thus, slices can be regarded as a way to split a coded picture to independently decodable pieces. In H.264/AVC and HEVC, in-picture prediction may be disabled across slice boundaries. Thus, slices can be regarded as a way to split a coded picture into independently decodable pieces, and slices are therefore often regarded as elementary units for transmission. In many cases, encoders may indicate in the bitstream which types of in-picture prediction are turned off across slice boundaries, and the decoder operation takes this information into account for example when concluding which prediction sources are available. For example, samples from a neighboring macroblock or CU may be regarded as unavailable for intra prediction, if the neighboring macroblock or CU resides in a different slice.

An elementary unit for the output of an H.264/AVC or HEVC encoder and the input of an H.264/AVC or HEVC decoder, respectively, is a Network Abstraction Layer (NAL) unit. For transport over packet-oriented networks or storage into structured files, NAL units may be encapsulated into packets or similar structures. A bytestream format has been specified in H.264/AVC and HEVC for transmission or storage environments that do not provide framing structures. The bytestream format separates NAL units from each other by attaching a start code in front of each NAL unit. To avoid false detection of NAL unit boundaries, encoders run a byte-oriented start code emulation prevention algorithm, which adds an emulation prevention byte to the NAL unit payload if a start code would have occurred otherwise. In order to enable straightforward gateway operation between packet- and stream-oriented systems, start code emulation prevention may always be performed regardless of whether the bytestream format is in use or not. A NAL unit may be defined as a syntax structure containing an indication of the type of data to follow and bytes containing that data in the form of an RBSP interspersed as necessary with emulation prevention bytes. A raw byte sequence payload (RBSP) may be defined as a syntax structure containing an integer number of bytes that is encapsulated in a NAL unit. An RBSP is either empty or has the form of a string of data bits containing syntax elements followed by an RBSP stop bit and followed by zero or more subsequent bits equal to 0.

NAL units consist of a header and payload. In H.264/AVC and HEVC, the NAL unit header indicates the type of the NAL unit.

H.264/AVC NAL unit header includes a 2-bit nal_ref idc syntax element, which when equal to 0 indicates that a coded slice contained in the NAL unit is a part of a non-reference picture and when greater than 0 indicates that a coded slice contained in the NAL unit is a part of a reference picture. The header for SVC and MVC NAL units may additionally contain various indications related to the scalability and multiview hierarchy.

In HEVC, a two-byte NAL unit header is used for all specified NAL unit types. The NAL unit header contains one reserved bit, a six-bit NAL unit type indication, a three-bit nuh_temporal_id_plus1 indication for temporal level (may be required to be greater than or equal to 1) and a six-bit nuh_layer_id syntax element. The temporal_id_plus 1 syntax element may be regarded as a temporal identifier for the NAL unit, and a zero-based TemporalId variable may be derived as follows: TemporalId=temporal_id_plus1−1. TemporalId equal to 0 corresponds to the lowest temporal level. The value of temporal_id_plus 1 is required to be non-zero in order to avoid start code emulation involving the two NAL unit header bytes. The bitstream created by excluding all VCL NAL units having a TemporalId greater than or equal to a selected value and including all other VCL NAL units remains conforming. Consequently, a picture having TemporalId equal to TID does not use any picture having a TemporalId greater than TID as inter prediction reference. A sub-layer or a temporal sub-layer may be defined to be a temporal scalable layer of a temporal scalable bitstream, consisting of VCL NAL units with a particular value of the TemporalId variable and the associated non-VCL NAL units. nuh_layer_id can be understood as a scalability layer identifier.

NAL units can be categorized into Video Coding Layer (VCL) NAL units and non-VCL NAL units. VCL NAL units are typically coded slice NAL units. In H.264/AVC, coded slice NAL units contain syntax elements representing one or more coded macroblocks, each of which corresponds to a block of samples in the uncompressed picture. In HEVC, VCL NAL units contain syntax elements representing one or more CU.

In H.264/AVC, a coded slice NAL unit can be indicated to be a coded slice in an Instantaneous Decoding Refresh (IDR) picture or coded slice in a non-IDR picture.

In HEVC, nal_unit_type of a VCL NAL unit may be considered to indicate the picture type. In HEVC, abbreviations for picture types may be defined as follows: trailing (TRAIL) picture, Temporal Sub-layer Access (TSA), Step-wise Temporal Sub-layer Access (STSA), Random Access Decodable Leading (RADL) picture, Random Access Skipped Leading (RASL) picture, Broken Link Access (BLA) picture, Instantaneous Decoding Refresh (IDR) picture, Clean Random Access (CRA) picture. The picture types may be categorized into intra random access point (IRAP) picture and non-IRAP pictures.

A Random Access Point (RAP) picture, which may also be referred to as an intra random access point (IRAP) picture, is a picture where each slice or slice segment has nal_unit_type in the range of 16 to 23, inclusive. A IRAP picture in an independent layer contains only intra-coded slices. An IRAP picture belonging to a predicted layer with nuh_layer_id value currLayerId may contain P, B, and I slices, cannot use inter prediction from other pictures with nuh_layer_id equal to currLayerId, and may use inter-layer prediction from its direct reference layers. In the present version of HEVC, an IRAP picture may be a BLA picture, a CRA picture or an IDR picture. The first picture in a bitstream containing a base layer is an IRAP picture at the base layer. Provided the necessary parameter sets are available when they need to be activated, an IRAP picture at an independent layer and all subsequent non-RASL pictures at the independent layer in decoding order can be correctly decoded without performing the decoding process of any pictures that precede the IRAP picture in decoding order. The IRAP picture belonging to a predicted layer with nuh_layer_id value currLayerId and all subsequent non-RASL pictures with nuh_layer_id equal to currLayerId in decoding order can be correctly decoded without performing the decoding process of any pictures with nuh_layer_id equal to currLayerId that precede the IRAP picture in decoding order, when the necessary parameter sets are available when they need to be activated and when the decoding of each direct reference layer of the layer with nuh_layer_id equal to currLayerId has been initialized (i.e. when LayerinitializedFlag[refLayerId] is equal to 1 for refLayerId equal to all nuh_layer_id values of the direct reference layers of the layer with nuh_layer_id equal to currLayerId). There may be pictures in a bitstream that contain only intra-coded slices that are not TRAP pictures.

In HEVC a CRA picture may be the first picture in the bitstream in decoding order, or may appear later in the bitstream. CRA pictures in HEVC allow so-called leading pictures that follow the CRA picture in decoding order but precede it in output order. Some of the leading pictures, so-called RASL pictures, may use pictures decoded before the CRA picture as a reference. Pictures that follow a CRA picture in both decoding and output order are decodable if random access is performed at the CRA picture, and hence clean random access is achieved similarly to the clean random access functionality of an IDR picture.

A CRA picture may have associated RADL or RASL pictures. When a CRA picture is the first picture in the bitstream in decoding order, the CRA picture is the first picture of a coded video sequence in decoding order, and any associated RASL pictures are not output by the decoder and may not be decodable, as they may contain references to pictures that are not present in the bitstream.

A leading picture is a picture that precedes the associated RAP picture in output order. The associated RAP picture is the previous RAP picture in decoding order (if present). A leading picture is either a RADL picture or a RASL picture.

All RASL pictures are leading pictures of an associated BLA or CRA picture. When the associated RAP picture is a BLA picture or is the first coded picture in the bitstream, the RASL picture is not output and may not be correctly decodable, as the RASL picture may contain references to pictures that are not present in the bitstream. However, a RASL picture can be correctly decoded if the decoding had started from a RAP picture before the associated RAP picture of the RASL picture. RASL pictures are not used as reference pictures for the decoding process of non-RASL pictures. When present, all RASL pictures precede, in decoding order, all trailing pictures of the same associated RAP picture. In some drafts of the HEVC standard, a RASL picture was referred to a Tagged for Discard (TFD) picture.

All RADL pictures are leading pictures. RADL pictures are not used as reference pictures for the decoding process of trailing pictures of the same associated RAP picture. When present, all RADL pictures precede, in decoding order, all trailing pictures of the same associated RAP picture. RADL pictures do not refer to any picture preceding the associated RAP picture in decoding order and can therefore be correctly decoded when the decoding starts from the associated RAP picture. In some drafts of the HEVC standard, a RADL picture was referred to a Decodable Leading Picture (DLP).

When a part of a bitstream starting from a CRA picture is included in another bitstream, the RASL pictures associated with the CRA picture might not be correctly decodable, because some of their reference pictures might not be present in the combined bitstream. To make such a splicing operation straightforward, the NAL unit type of the CRA picture can be changed to indicate that it is a BLA picture. The RASL pictures associated with a BLA picture may not be correctly decodable hence are not be output/displayed. Furthermore, the RASL pictures associated with a BLA picture may be omitted from decoding.

A BLA picture may be the first picture in the bitstream in decoding order, or may appear later in the bitstream. Each BLA picture begins a new coded video sequence, and has similar effect on the decoding process as an IDR picture. However, a BLA picture contains syntax elements that specify a non-empty reference picture set. When a BLA picture has nal_unit_type equal to BLA_W_LP, it may have associated RASL pictures, which are not output by the decoder and may not be decodable, as they may contain references to pictures that are not present in the bitstream. When a BLA picture has nal_unit_type equal to BLA_W_LP, it may also have associated RADL pictures, which are specified to be decoded. When a BLA picture has nal_unit_type equal to BLA_W_DLP, it does not have associated RASL pictures but may have associated RADL pictures, which are specified to be decoded. When a BLA picture has nal_unit_type equal to BLA_N_LP, it does not have any associated leading pictures.

An IDR picture having nal_unit_type equal to IDR_N_LP does not have associated leading pictures present in the bitstream. An IDR picture having nal_unit_type equal to IDR_W_LP does not have associated RASL pictures present in the bitstream, but may have associated RADL pictures in the bitstream.

When the value of nal_unit_type is equal to TRAIL_N, TSA_N, STSA_N, RADL_N, RASL_N, RSV_VCL_N10, RSV_VCL_N12, or RSV_VCL_N14, the decoded picture is not used as a reference for any other picture of the same temporal sub-layer. That is, in HEVC, when the value of nal_unit_type is equal to TRAIL_N, TSA_N, STSA_N, RADL_N, RASL_N, RSV_VCL_N10, RSV_VCL_N12, or RSV_VCL_N14, the decoded picture is not included in any of RefPicSetStCurrBefore, RefPicSetStCurrAfter and RefPicSetLtCurr of any picture with the same value of TemporalId. A coded picture with nal_unit_type equal to TRAIL_N, TSA_N, STSA_N, RADL_N, RASL_N, RSV_VCL_N10, RSV_VCL_N12, or RSV_VCL_N14 may be discarded without affecting the decodability of other pictures with the same value of TemporalId.

A trailing picture may be defined as a picture that follows the associated RAP picture in output order. Any picture that is a trailing picture does not have nal_unit_type equal to RADL_N, RADL_R, RASL_N or RASL_R. Any picture that is a leading picture may be constrained to precede, in decoding order, all trailing pictures that are associated with the same RAP picture. No RASL pictures are present in the bitstream that are associated with a BLA picture having nal_unit_type equal to BLA_W_DLP or BLA_N_LP. No RADL pictures are present in the bitstream that are associated with a BLA picture having nal_unit_type equal to BLA_N_LP or that are associated with an IDR picture having nal_unit_type equal to IDR_N_LP. Any RASL picture associated with a CRA or BLA picture may be constrained to precede any RADL picture associated with the CRA or BLA picture in output order. Any RASL picture associated with a CRA picture may be constrained to follow, in output order, any other RAP picture that precedes the CRA picture in decoding order.

In HEVC there are two picture types, the TSA and STSA picture types that can be used to indicate temporal sub-layer switching points. If temporal sub-layers with TemporalId up to N had been decoded until the TSA or STSA picture (exclusive) and the TSA or STSA picture has TemporalId equal to N+1, the TSA or STSA picture enables decoding of all subsequent pictures (in decoding order) having TemporalId equal to N+1. The TSA picture type may impose restrictions on the TSA picture itself and all pictures in the same sub-layer that follow the TSA picture in decoding order. None of these pictures is allowed to use inter prediction from any picture in the same sub-layer that precedes the TSA picture in decoding order. The TSA definition may further impose restrictions on the pictures in higher sub-layers that follow the TSA picture in decoding order. None of these pictures is allowed to refer a picture that precedes the TSA picture in decoding order if that picture belongs to the same or higher sub-layer as the TSA picture. TSA pictures have TemporalId greater than 0. The STSA is similar to the TSA picture but does not impose restrictions on the pictures in higher sub-layers that follow the STSA picture in decoding order and hence enable up-switching only onto the sub-layer where the STSA picture resides.

A non-VCL NAL unit may be for example one of the following types: a sequence parameter set, a picture parameter set, a supplemental enhancement information (SEI) NAL unit, an access unit delimiter, an end of sequence NAL unit, an end of bitstream NAL unit, or a filler data NAL unit. Parameter sets may be needed for the reconstruction of decoded pictures, whereas many of the other non-VCL NAL units are not necessary for the reconstruction of decoded sample values. An access unit delimiter NAL unit, when present, may be required to be the first NAL unit, in decoding order, of an access unit and can therefore be used to indicate the start of an access unit. It has been proposed that an indicator, such as an SEI message or a dedicated NAL unit, for a coded unit completion can be included in a bitstream or decoded from a bitstream. The coded unit completion indicator may additionally comprise information whether it signifies an end of a coded picture unit, in which case it may additionally comprise information of a combination of layers for which the coded unit completion indicator signifies the end of an access unit.

Parameters that remain unchanged through a coded video sequence may be included in a sequence parameter set. In addition to the parameters that may be needed by the decoding process, the sequence parameter set may optionally contain video usability information (VUI), which includes parameters that may be important for buffering, picture output timing, rendering, and resource reservation. There are three NAL units specified in H.264/AVC to carry sequence parameter sets: the sequence parameter set NAL unit containing all the data for H.264/AVC VCL NAL units in the sequence, the sequence parameter set extension NAL unit containing the data for auxiliary coded pictures, and the subset sequence parameter set for MVC and SVC VCL NAL units. In HEVC a sequence parameter set RBSP includes parameters that can be referred to by one or more picture parameter set RBSPs or one or more SEI NAL units containing a buffering period SEI message. A picture parameter set contains such parameters that are likely to be unchanged in several coded pictures. A picture parameter set RBSP may include parameters that can be referred to by the coded slice NAL units of one or more coded pictures.

In HEVC, a video parameter set (VPS) may be defined as a syntax structure containing syntax elements that apply to zero or more entire coded video sequences as determined by the content of a syntax element found in the SPS referred to by a syntax element found in the PPS referred to by a syntax element found in each slice segment header.

A video parameter set RBSP may include parameters that can be referred to by one or more sequence parameter set RBSPs.

The relationship and hierarchy between video parameter set (VPS), sequence parameter set (SPS), and picture parameter set (PPS) may be described as follows. VPS resides one level above SPS in the parameter set hierarchy and in the context of scalability and/or 3D video. VPS may include parameters that are common for all slices across all (scalability or view) layers in the entire coded video sequence. SPS includes the parameters that are common for all slices in a particular (scalability or view) layer in the entire coded video sequence, and may be shared by multiple (scalability or view) layers. PPS includes the parameters that are common for all slices in a particular layer representation (the representation of one scalability or view layer in one access unit) and are likely to be shared by all slices in multiple layer representations.

VPS may provide information about the dependency relationships of the layers in a bitstream, as well as many other information that are applicable to all slices across all (scalability or view) layers in the entire coded video sequence. VPS may be considered to comprise two parts, the base VPS and a VPS extension, where the VPS extension may be optionally present. In HEVC, the base VPS may be considered to comprise the video_parameter_set_rbsp( ) syntax structure without the vps_extension( ) syntax structure. The video_parameter_set_rbsp( ) syntax structure was primarily specified already for HEVC version 1 and includes syntax elements which may be of use for base layer decoding. In HEVC, the VPS extension may be considered to comprise the vps_extension( ) syntax structure. The vps_extension( ) syntax structure was specified in HEVC version 2 primarily for multi-layer extensions and comprises syntax elements which may be of use for decoding of one or more non-base layers, such as syntax elements indicating layer dependency relations.

H.264/AVC and HEVC syntax allows many instances of parameter sets, and each instance is identified with a unique identifier. In order to limit the memory usage needed for parameter sets, the value range for parameter set identifiers has been limited. In H.264/AVC and HEVC, each slice header includes the identifier of the picture parameter set that is active for the decoding of the picture that contains the slice, and each picture parameter set contains the identifier of the active sequence parameter set. Consequently, the transmission of picture and sequence parameter sets does not have to be accurately synchronized with the transmission of slices. Instead, it is sufficient that the active sequence and picture parameter sets are received at any moment before they are referenced, which allows transmission of parameter sets “out-of-band” using a more reliable transmission mechanism compared to the protocols used for the slice data. For example, parameter sets can be included as a parameter in the session description for Real-time Transport Protocol (RTP) sessions. If parameter sets are transmitted in-band, they can be repeated to improve error robustness.

A parameter set may be activated by a reference from a slice or from another active parameter set or in some cases from another syntax structure such as a buffering period SEI message.

A SEI NAL unit may contain one or more SEI messages, which are not required for the decoding of output pictures but may assist in related processes, such as picture output timing, rendering, error detection, error concealment, and resource reservation. Several SEI messages are specified in H.264/AVC and HEVC, and the user data SEI messages enable organizations and companies to specify SEI messages for their own use. H.264/AVC and HEVC contain the syntax and semantics for the specified SEI messages but no process for handling the messages in the recipient is defined. Consequently, encoders are required to follow the H.264/AVC standard or the HEVC standard when they create SEI messages, and decoders conforming to the H.264/AVC standard or the HEVC standard, respectively, are not required to process SEI messages for output order conformance. One of the reasons to include the syntax and semantics of SEI messages in H.264/AVC and HEVC is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified.

In HEVC, there are two types of SEI NAL units, namely the suffix SEI NAL unit and the prefix SEI NAL unit, having a different nal_unit_type value from each other. The SEI message(s) contained in a suffix SEI NAL unit are associated with the VCL NAL unit preceding, in decoding order, the suffix SEI NAL unit. The SEI message(s) contained in a prefix SEI NAL unit are associated with the VCL NAL unit following, in decoding order, the prefix SEI NAL unit.

A coded picture is a coded representation of a picture. A coded picture in H.264/AVC comprises the VCL NAL units that are required for the decoding of the picture. In H.264/AVC, a coded picture can be a primary coded picture or a redundant coded picture. A primary coded picture is used in the decoding process of valid bitstreams, whereas a redundant coded picture is a redundant representation that should only be decoded when the primary coded picture cannot be successfully decoded. In HEVC, no redundant coded picture has been specified.

In H.264/AVC, an access unit (AU) comprises a primary coded picture and those NAL units that are associated with it. In H.264/AVC, the appearance order of NAL units within an access unit is constrained as follows. An optional access unit delimiter NAL unit may indicate the start of an access unit. It is followed by zero or more SEI NAL units. The coded slices of the primary coded picture appear next. In H.264/AVC, the coded slice of the primary coded picture may be followed by coded slices for zero or more redundant coded pictures. A redundant coded picture is a coded representation of a picture or a part of a picture. A redundant coded picture may be decoded if the primary coded picture is not received by the decoder for example due to a loss in transmission or a corruption in physical storage medium.

In HEVC, a coded picture may be defined as a coded representation of a picture containing all coding tree units of the picture. In HEVC, an access unit (AU) may be defined as a set of NAL units that are associated with each other according to a specified classification rule, are consecutive in decoding order, and contain at most one picture with any specific value of nuh_layer_id. In addition to containing the VCL NAL units of the coded picture, an access unit may also contain non-VCL NAL units.

It may be required that coded pictures appear in certain order within an access unit. For example a coded picture with nuh_layer_id equal to nuhLayerIdA may be required to precede, in decoding order, all coded pictures with nuh_layer_id greater than nuhLayerIdA in the same access unit.

In HEVC, a picture unit may be defined as a set of NAL units that contain all VCL NAL units of a coded picture and their associated non-VCL NAL units. An associated VCL NAL unit for a non-VCL NAL unit may be defined as the preceding VCL NAL unit, in decoding order, of the non-VCL NAL unit for certain types of non-VCL NAL units and the next VCL NAL unit, in decoding order, of the non-VCL NAL unit for other types of non-VCL NAL units. An associated non-VCL NAL unit for a VCL NAL unit may be defined to be the a non-VCL NAL unit for which the VCL NAL unit is the associated VCL NAL unit. For example, in HEVC, an associated VCL NAL unit may be defined as the preceding VCL NAL unit in decoding order for a non-VCL NAL unit with nal_unit_type equal to EOS_NUT, EOB_NUT, FD_NUT, or SUFFIX_SEI_NUT, or in the ranges of RSV_NVCL45..RSV_NVCL47 or UNSPEC56..UNSPEC63; or otherwise the next VCL NAL unit in decoding order.

A bitstream may be defined as a sequence of bits, in the form of a NAL unit stream or a byte stream, that forms the representation of coded pictures and associated data forming one or more coded video sequences. A first bitstream may be followed by a second bitstream in the same logical channel, such as in the same file or in the same connection of a communication protocol. An elementary stream (in the context of video coding) may be defined as a sequence of one or more bitstreams. The end of the first bitstream may be indicated by a specific NAL unit, which may be referred to as the end of bitstream (EOB) NAL unit and which is the last NAL unit of the bitstream. In HEVC and its current draft extensions, the EOB NAL unit is required to have nuh_layer_id equal to 0.

In H.264/AVC, a coded video sequence is defined to be a sequence of consecutive access units in decoding order from an IDR access unit, inclusive, to the next IDR access unit, exclusive, or to the end of the bitstream, whichever appears earlier.

In HEVC, a coded video sequence (CVS) may be defined, for example, as a sequence of access units that consists, in decoding order, of an IRAP access unit with NoRaslOutputFlag equal to 1, followed by zero or more access units that are not IRAP access units with NoRaslOutputFlag equal to 1, including all subsequent access units up to but not including any subsequent access unit that is an IRAP access unit with NoRaslOutputFlag equal to 1. An IRAP access unit may be defined as an access unit in which the base layer picture is an IRAP picture. The value of NoRaslOutputFlag is equal to 1 for each IDR picture, each BLA picture, and each IRAP picture that is the first picture in that particular layer in the bitstream in decoding order, is the first IRAP picture that follows an end of sequence NAL unit having the same value of nuh_layer_id in decoding order. In multi-layer HEVC, the value of NoRaslOutputFlag is equal to 1 for each IRAP picture when its nuh_layer_id is such that LayerinitializedFlag[nuh_layer_id] is equal to 0 and LayerinitializedFlag[refLayerId] is equal to 1 for all values of refLayerId equal to IdDirectRefLayer[nuh_layer_id][j], where j is in the range of 0 to NumDirectRefLayers[nuh_layer_id]−1, inclusive. Otherwise, the value of NoRaslOutputFlag is equal to HandleCraAsBlaFlag. NoRaslOutputFlag equal to 1 has an impact that the RASL pictures associated with the IRAP picture for which the NoRaslOutputFlag is set are not output by the decoder. There may be means to provide the value of HandleCraAsBlaFlag to the decoder from an external entity, such as a player or a receiver, which may control the decoder. HandleCraAsBlaFlag may be set to 1 for example by a player that seeks to a new position in a bitstream or tunes into a broadcast and starts decoding and then starts decoding from a CRA picture. When HandleCraAsBlaFlag is equal to 1 for a CRA picture, the CRA picture is handled and decoded as if it were a BLA picture.

In HEVC, a coded video sequence may additionally or alternatively (to the specification above) be specified to end, when a specific NAL unit, which may be referred to as an end of sequence (EOS) NAL unit, appears in the bitstream and has nuh_layer_id equal to 0.

In HEVC, a coded video sequence group (CVSG) may be defined, for example, as one or more consecutive CVSs in decoding order that collectively consist of an IRAP access unit that activates a VPS RBSP firstVpsRbsp that was not already active followed by all subsequent access units, in decoding order, for which firstVpsRbsp is the active VPS RBSP up to the end of the bitstream or up to but excluding the access unit that activates a different VPS RBSP than firstVpsRbsp, whichever is earlier in decoding order.

The bitstream syntax of H.264/AVC and HEVC indicates whether a particular picture is a reference picture for inter prediction of any other picture. Pictures of any coding type (I, P, B) can be reference pictures or non-reference pictures in H.264/AVC and HEVC.

In HEVC, a reference picture set (RPS) syntax structure and decoding process are used. A reference picture set valid or active for a picture includes all the reference pictures used as reference for the picture and all the reference pictures that are kept marked as “used for reference” for any subsequent pictures in decoding order. There are six subsets of the reference picture set, which are referred to as namely RefPicSetStCurr0 (a.k.a. RefPicSetStCurrBefore), RefPicSetStCurr1 (a.k.a. RefPicSetStCurrAfter), RefPicSetStFoll0, RefPicSetStFoll1, RefPicSetLtCurr, and RefPicSetLtFoll. RefPicSetStFoll0 and RefPicSetStFoll1 may also be considered to form jointly one subset RefPicSetStFoll. The notation of the six subsets is as follows. “Curr” refers to reference pictures that are included in the reference picture lists of the current picture and hence may be used as inter prediction reference for the current picture. “Foll” refers to reference pictures that are not included in the reference picture lists of the current picture but may be used in subsequent pictures in decoding order as reference pictures. “St” refers to short-term reference pictures, which may generally be identified through a certain number of least significant bits of their POC value. “Lt” refers to long-term reference pictures, which are specifically identified and generally have a greater difference of POC values relative to the current picture than what can be represented by the mentioned certain number of least significant bits. “0” refers to those reference pictures that have a smaller POC value than that of the current picture. “1” refers to those reference pictures that have a greater POC value than that of the current picture. RefPicSetStCurr0, RefPicSetStCurr1, RefPicSetStFoll0 and RefPicSetStFoll1 are collectively referred to as the short-term subset of the reference picture set. RefPicSetLtCurr and RefPicSetLtFoll are collectively referred to as the long-term subset of the reference picture set.

In HEVC, a reference picture set may be specified in a sequence parameter set and taken into use in the slice header through an index to the reference picture set. A reference picture set may also be specified in a slice header. A reference picture set may be coded independently or may be predicted from another reference picture set (known as inter-RPS prediction). In both types of reference picture set coding, a flag (used_by_curr_pic_X_flag) is additionally sent for each reference picture indicating whether the reference picture is used for reference by the current picture (included in a *Curr list) or not (included in a *Foll list). Pictures that are included in the reference picture set used by the current slice are marked as “used for reference”, and pictures that are not in the reference picture set used by the current slice are marked as “unused for reference”. If the current picture is an IDR picture, RefPicSetStCurr0, RefPicSetStCurr1, RefPicSetStFoll0, RefPicSetStFoll1, RefPicSetLtCurr, and RefPicSetLtFoll are all set to empty.

A Decoded Picture Buffer (DPB) may be used in the encoder and/or in the decoder. There are two reasons to buffer decoded pictures, for references in inter prediction and for reordering decoded pictures into output order. As H.264/AVC and HEVC provide a great deal of flexibility for both reference picture marking and output reordering, separate buffers for reference picture buffering and output picture buffering may waste memory resources. Hence, the DPB may include a unified decoded picture buffering process for reference pictures and output reordering. A decoded picture may be removed from the DPB when it is no longer used as a reference and is not needed for output.

In many coding modes of H.264/AVC and HEVC, the reference picture for inter prediction is indicated with an index to a reference picture list. The index may be coded with variable length coding, which usually causes a smaller index to have a shorter value for the corresponding syntax element. In H.264/AVC and HEVC, two reference picture lists (reference picture list 0 and reference picture list 1) are generated for each bi-predictive (B) slice, and one reference picture list (reference picture list 0) is formed for each inter-coded (P) slice.

A reference picture list, such as reference picture list 0 and reference picture list 1, is typically constructed in two steps: First, an initial reference picture list is generated. The initial reference picture list may be generated for example on the basis of frame_num, POC, temporal_id (or TemporalId or alike), or information on the prediction hierarchy such as GOP structure, or any combination thereof. Second, the initial reference picture list may be reordered by reference picture list reordering (RPLR) commands, also known as reference picture list modification syntax structure, which may be contained in slice headers. In H.264/AVC, the RPLR commands indicate the pictures that are ordered to the beginning of the respective reference picture list. This second step may also be referred to as the reference picture list modification process, and the RPLR commands may be included in a reference picture list modification syntax structure. If reference picture sets are used, the reference picture list 0 may be initialized to contain RefPicSetStCurr0 first, followed by RefPicSetStCurr1, followed by RefPicSetLtCurr. Reference picture list 1 may be initialized to contain RefPicSetStCurr1 first, followed by RefPicSetStCurr0. In HEVC, the initial reference picture lists may be modified through the reference picture list modification syntax structure, where pictures in the initial reference picture lists may be identified through an entry index to the list. In other words, in HEVC, reference picture list modification is encoded into a syntax structure comprising a loop over each entry in the final reference picture list, where each loop entry is a fixed-length coded index to the initial reference picture list and indicates the picture in ascending position order in the final reference picture list.

Many coding standards, including H.264/AVC and HEVC, may have decoding process to derive a reference picture index to a reference picture list, which may be used to indicate which one of the multiple reference pictures is used for inter prediction for a particular block. A reference picture index may be coded by an encoder into the bitstream is some inter coding modes or it may be derived (by an encoder and a decoder) for example using neighboring blocks in some other inter coding modes.

Scalable video coding may refer to coding structure where one bitstream can contain multiple representations of the content, for example, at different bitrates, resolutions or frame rates. In these cases the receiver can extract the desired representation depending on its characteristics (e.g. resolution that matches best the display device). Alternatively, a server or a network element can extract the portions of the bitstream to be transmitted to the receiver depending on e.g. the network characteristics or processing capabilities of the receiver. A meaningful decoded representation can be produced by decoding only certain parts of a scalable bit stream. A scalable bitstream typically consists of a “base layer” providing the lowest quality video available and one or more enhancement layers that enhance the video quality when received and decoded together with the lower layers. In order to improve coding efficiency for the enhancement layers, the coded representation of that layer typically depends on the lower layers. E.g. the motion and mode information of the enhancement layer can be predicted from lower layers. Similarly the pixel data of the lower layers can be used to create prediction for the enhancement layer.

In some scalable video coding schemes, a video signal can be encoded into a base layer and one or more enhancement layers. An enhancement layer may enhance, for example, the temporal resolution (i.e., the frame rate), the spatial resolution, or simply the quality of the video content represented by another layer or part thereof. Each layer together with all its dependent layers is one representation of the video signal, for example, at a certain spatial resolution, temporal resolution and quality level. In this document, we refer to a scalable layer together with all of its dependent layers as a “scalable layer representation”. The portion of a scalable bitstream corresponding to a scalable layer representation can be extracted and decoded to produce a representation of the original signal at certain fidelity.

Scalability modes or scalability dimensions may include but are not limited to the following:
Quality scalability: Base layer pictures are coded at a lower quality than enhancement layer pictures, which may be achieved for example using a greater quantization parameter value (i.e., a greater quantization step size for transform coefficient quantization) in the base layer than in the enhancement layer. Quality scalability may be further categorized into fine-grain or fine-granularity scalability (FGS), medium-grain or medium-granularity scalability (MGS), and/or coarse-grain or coarse-granularity scalability (CGS), as described below.
Spatial scalability: Base layer pictures are coded at a lower resolution (i.e. have fewer samples) than enhancement layer pictures. Spatial scalability and quality scalability, particularly its coarse-grain scalability type, may sometimes be considered the same type of scalability.
Bit-depth scalability: Base layer pictures are coded at lower bit-depth (e.g. 8 bits) than enhancement layer pictures (e.g. 10 or 12 bits).
Dynamic range scalability: Scalable layers represent a different dynamic range and/or images obtained using a different tone mapping function and/or a different optical transfer function.
Chroma format scalability: Base layer pictures provide lower spatial resolution in chroma sample arrays (e.g. coded in 4:2:0 chroma format) than enhancement layer pictures (e.g. 4:4:4 format).
Color gamut scalability: enhancement layer pictures have a richer/broader color representation range than that of the base layer pictures—for example the enhancement layer may have UHDTV (ITU-R BT.2020) color gamut and the base layer may have the ITU-R BT.709 color gamut.
View scalability, which may also be referred to as multiview coding. The base layer represents a first view, whereas an enhancement layer represents a second view.
Depth scalability, which may also be referred to as depth-enhanced coding. A layer or some layers of a bitstream may represent texture view(s), while other layer or layers may represent depth view(s).
Region-of-interest scalability (as described below).
Interlaced-to-progressive scalability (also known as field-to-frame scalability): coded interlaced source content material of the base layer is enhanced with an enhancement layer to represent progressive source content. The coded interlaced source content in the base layer may comprise coded fields, coded frames representing field pairs, or a mixture of them. In the interlace-to-progressive scalability, the base-layer picture may be resampled so that it becomes a suitable reference picture for one or more enhancement-layer pictures.
Hybrid codec scalability (also known as coding standard scalability): In hybrid codec scalability, the bitstream syntax, semantics and decoding process of the base layer and the enhancement layer are specified in different video coding standards. Thus, base layer pictures are coded according to a different coding standard or format than enhancement layer pictures. For example, the base layer may be coded with H.264/AVC and an enhancement layer may be coded with an HEVC multi-layer extension. An external base layer picture may be defined as a decoded picture that is provided by external means for the enhancement-layer decoding process and that is treated like a decoded base-layer picture for the enhancement layer decoding process. SHVC and MV-HEVC allow the use of external base layer pictures.

It should be understood that many of the scalability types may be combined and applied together. For example color gamut scalability and bit-depth scalability may be combined.

The term layer may be used in context of any type of scalability, including view scalability and depth enhancements. An enhancement layer may refer to any type of an enhancement, such as SNR, spatial, multiview, depth, bit-depth, chroma format, and/or color gamut enhancement. A base layer may refer to any type of a base video sequence, such as a base view, a base layer for SNR/spatial scalability, or a texture base view for depth-enhanced video coding.

Various technologies for providing three-dimensional (3D) video content are currently investigated and developed. It may be considered that in stereoscopic or two-view video, one video sequence or view is presented for the left eye while a parallel view is presented for the right eye. More than two parallel views may be needed for applications which enable viewpoint switching or for autostereoscopic displays which may present a large number of views simultaneously and let the viewers to observe the content from different viewpoints.

A view may be defined as a sequence of pictures representing one camera or viewpoint. The pictures representing a view may also be called view components. In other words, a view component may be defined as a coded representation of a view in a single access unit. In multiview video coding, more than one view is coded in a bitstream. Since views are typically intended to be displayed on stereoscopic or multiview autostrereoscopic display or to be used for other 3D arrangements, they typically represent the same scene and are content-wise partly overlapping although representing different viewpoints to the content. Hence, inter-view prediction may be utilized in multiview video coding to take advantage of inter-view correlation and improve compression efficiency. One way to realize inter-view prediction is to include one or more decoded pictures of one or more other views in the reference picture list(s) of a picture being coded or decoded residing within a first view. View scalability may refer to such multi-view video coding or multiview video bitstreams, which enable removal or omission of one or more coded views, while the resulting bitstream remains conforming and represents video with a smaller number of views than originally.

Region of Interest (ROI) coding may be defined to refer to coding a particular region within a video at a higher fidelity. There exists several methods for encoders and/or other entities to determine ROIs from input pictures to be encoded. For example, face detection may be used and faces may be determined to be ROIs. Additionally or alternatively, in another example, objects that are in focus may be detected and determined to be ROIs, while objects out of focus are determined to be outside ROIs. Additionally or alternatively, in another example, the distance to objects may be estimated or known, e.g. on the basis of a depth sensor, and ROIs may be determined to be those objects that are relatively close to the camera rather than in the background.

ROI scalability may be defined as a type of scalability wherein an enhancement layer enhances only part of a reference-layer picture e.g. spatially, quality-wise, in bit-depth, and/or along other scalability dimensions. As ROI scalability may be used together with other types of scalabilities, it may be considered to form a different categorization of scalability types. There exists several different applications for ROI coding with different requirements, which may be realized by using ROI scalability. For example, an enhancement layer can be transmitted to enhance the quality and/or a resolution of a region in the base layer. A decoder receiving both enhancement and base layer bitstream might decode both layers and overlay the decoded pictures on top of each other and display the final picture.

The spatial correspondence of a reference-layer picture and an enhancement-layer picture may be inferred or may be indicated with one or more types of so-called reference layer location offsets. In HEVC, reference layer location offsets may be included in the PPS by the encoder and decoded from the PPS by the decoder. Reference layer location offsets may be used for but are not limited to achieving ROI scalability. Reference layer location offsets may comprise one or more of scaled reference layer offsets, reference region offsets, and resampling phase sets. Scaled reference layer offsets may be considered to specify the horizontal and vertical offsets between the sample in the current picture that is collocated with the top-left luma sample of the reference region in a decoded picture in a reference layer and the horizontal and vertical offsets between the sample in the current picture that is collocated with the bottom-right luma sample of the reference region in a decoded picture in a reference layer. Another way is to consider scaled reference layer offsets to specify the positions of the corner samples of the upsampled reference region relative to the respective corner samples of the enhancement layer picture. The scaled reference layer offset values may be signed. Reference region offsets may be considered to specify the horizontal and vertical offsets between the top-left luma sample of the reference region in the decoded picture in a reference layer and the top-left luma sample of the same decoded picture as well as the horizontal and vertical offsets between the bottom-right luma sample of the reference region in the decoded picture in a reference layer and the bottom-right luma sample of the same decoded picture. The reference region offset values may be signed. A resampling phase set may be considered to specify the phase offsets used in resampling process of a source picture for inter-layer prediction. Different phase offsets may be provided for luma and chroma components.

Hybrid codec scalability may be used together with any types of scalability, such as temporal, quality, spatial, multi-view, depth-enhanced, auxiliary picture, bit-depth, color gamut, chroma format, and/or ROI scalability. As hybrid codec scalability may be used together with other types of scalabilities, it may be considered to form a different categorization of scalability types.

The use of hybrid codec scalability may be indicated for example in an enhancement layer bitstream. For example, in multi-layer HEVC, the use of hybrid codec scalability may be indicated in the VPS, for example using the syntax element vps_base_layer_internal_flag.

Some scalable video coding schemes may require IRAP pictures to be aligned across layers in a manner that either all pictures in an access unit are IRAP pictures or no picture in an access unit is an IRAP picture. Other scalable video coding schemes, such as the multi-layer extensions of HEVC, may allow IRAP pictures that are not aligned, i.e. that one or more pictures in an access unit are IRAP pictures, while one or more other pictures in an access unit are not IRAP pictures. Scalable bitstreams with IRAP pictures or similar that are not aligned across layers may be used for example for providing more frequent IRAP pictures in the base layer, where they may have a smaller coded size due to e.g. a smaller spatial resolution. A process or mechanism for layer-wise start-up of the decoding may be included in a video decoding scheme. Decoders may hence start decoding of a bitstream when a base layer contains an IRAP picture and step-wise start decoding other layers when they contain IRAP pictures. In other words, in a layer-wise start-up of the decoding mechanism or process, decoders progressively increase the number of decoded layers (where layers may represent an enhancement in spatial resolution, quality level, views, additional components such as depth, or a combination) as subsequent pictures from additional enhancement layers are decoded in the decoding process. The progressive increase of the number of decoded layers may be perceived for example as a progressive improvement of picture quality (in case of quality and spatial scalability).

A layer-wise start-up mechanism may generate unavailable pictures for the reference pictures of the first picture in decoding order in a particular enhancement layer. Alternatively, a decoder may omit the decoding of pictures preceding, in decoding order, the IRAP picture from which the decoding of a layer can be started. These pictures that may be omitted may be specifically labeled by the encoder or another entity within the bitstream. For example, one or more specific NAL unit types may be used for them. These pictures, regardless of whether they are specifically marked with a NAL unit type or inferred e.g. by the decoder, may be referred to as cross-layer random access skip (CL-RAS) pictures. The decoder may omit the output of the generated unavailable pictures and the decoded CL-RAS pictures.

Scalability may be enabled in two basic ways. Either by introducing new coding modes for performing prediction of pixel values or syntax from lower layers of the scalable representation or by placing the lower layer pictures to a reference picture buffer (e.g. a decoded picture buffer, DPB) of the higher layer. The first approach may be more flexible and thus may provide better coding efficiency in most cases. However, the second, reference frame based scalability, approach may be implemented efficiently with minimal changes to single layer codecs while still achieving majority of the coding efficiency gains available. Essentially a reference frame based scalability codec may be implemented by utilizing the same hardware or software implementation for all the layers, just taking care of the DPB management by external means.

A scalable video encoder for quality scalability (also known as Signal-to-Noise or SNR) and/or spatial scalability may be implemented as follows. For a base layer, a conventional non-scalable video encoder and decoder may be used. The reconstructed/decoded pictures of the base layer are included in the reference picture buffer and/or reference picture lists for an enhancement layer. In case of spatial scalability, the reconstructed/decoded base-layer picture may be upsampled prior to its insertion into the reference picture lists for an enhancement-layer picture. The base layer decoded pictures may be inserted into a reference picture list(s) for coding/decoding of an enhancement layer picture similarly to the decoded reference pictures of the enhancement layer. Consequently, the encoder may choose a base-layer reference picture as an inter prediction reference and indicate its use with a reference picture index in the coded bitstream. The decoder decodes from the bitstream, for example from a reference picture index, that a base-layer picture is used as an inter prediction reference for the enhancement layer. When a decoded base-layer picture is used as the prediction reference for an enhancement layer, it is referred to as an inter-layer reference picture.

While the previous paragraph described a scalable video codec with two scalability layers with an enhancement layer and a base layer, it needs to be understood that the description can be generalized to any two layers in a scalability hierarchy with more than two layers. In this case, a second enhancement layer may depend on a first enhancement layer in encoding and/or decoding processes, and the first enhancement layer may therefore be regarded as the base layer for the encoding and/or decoding of the second enhancement layer. Furthermore, it needs to be understood that there may be inter-layer reference pictures from more than one layer in a reference picture buffer or reference picture lists of an enhancement layer, and each of these inter-layer reference pictures may be considered to reside in a base layer or a reference layer for the enhancement layer being encoded and/or decoded. Furthermore, it needs to be understood that other types of inter-layer processing than reference-layer picture upsampling may take place instead or additionally. For example, the bit-depth of the samples of the reference-layer picture may be converted to the bit-depth of the enhancement layer and/or the sample values may undergo a mapping from the color space of the reference layer to the color space of the enhancement layer.

A scalable video coding and/or decoding scheme may use multi-loop coding and/or decoding, which may be characterized as follows. In the encoding/decoding, a base layer picture may be reconstructed/decoded to be used as a motion-compensation reference picture for subsequent pictures, in coding/decoding order, within the same layer or as a reference for inter-layer (or inter-view or inter-component) prediction. The reconstructed/decoded base layer picture may be stored in the DPB. An enhancement layer picture may likewise be reconstructed/decoded to be used as a motion-compensation reference picture for subsequent pictures, in coding/decoding order, within the same layer or as reference for inter-layer (or inter-view or inter-component) prediction for higher enhancement layers, if any. In addition to reconstructed/decoded sample values, syntax element values of the base/reference layer or variables derived from the syntax element values of the base/reference layer may be used in the inter-layer/inter-component/inter-view prediction.

Inter-layer prediction may be defined as prediction in a manner that is dependent on data elements (e.g., sample values or motion vectors) of reference pictures from a different layer than the layer of the current picture (being encoded or decoded). Many types of inter-layer prediction exist and may be applied in a scalable video encoder/decoder. The available types of inter-layer prediction may for example depend on the coding profile according to which the bitstream or a particular layer within the bitstream is being encoded or, when decoding, the coding profile that the bitstream or a particular layer within the bitstream is indicated to conform to. Alternatively or additionally, the available types of inter-layer prediction may depend on the types of scalability or the type of an scalable codec or video coding standard amendment (e.g. SHVC, MV-HEVC, or 3D-HEVC) being used.

The types of inter-layer prediction may comprise, but are not limited to, one or more of the following: inter-layer sample prediction, inter-layer motion prediction, inter-layer residual prediction. In inter-layer sample prediction, at least a subset of the reconstructed sample values of a source picture for inter-layer prediction are used as a reference for predicting sample values of the current picture. In inter-layer motion prediction, at least a subset of the motion vectors of a source picture for inter-layer prediction are used as a reference for predicting motion vectors of the current picture. Typically, predicting information on which reference pictures are associated with the motion vectors is also included in inter-layer motion prediction. For example, the reference indices of reference pictures for the motion vectors may be inter-layer predicted and/or the picture order count or any other identification of a reference picture may be inter-layer predicted. In some cases, inter-layer motion prediction may also comprise prediction of block coding mode, header information, block partitioning, and/or other similar parameters. In some cases, coding parameter prediction, such as inter-layer prediction of block partitioning, may be regarded as another type of inter-layer prediction. In inter-layer residual prediction, the prediction error or residual of selected blocks of a source picture for inter-layer prediction is used for predicting the current picture. In multiview-plus-depth coding, such as 3D-HEVC, cross-component inter-layer prediction may be applied, in which a picture of a first type, such as a depth picture, may affect the inter-layer prediction of a picture of a second type, such as a conventional texture picture. For example, disparity-compensated inter-layer sample value and/or motion prediction may be applied, where the disparity may be at least partially derived from a depth picture.

A direct reference layer may be defined as a layer that may be used for inter-layer prediction of another layer for which the layer is the direct reference layer. A direct predicted layer may be defined as a layer for which another layer is a direct reference layer. An indirect reference layer may be defined as a layer that is not a direct reference layer of a second layer but is a direct reference layer of a third layer that is a direct reference layer or indirect reference layer of a direct reference layer of the second layer for which the layer is the indirect reference layer. An indirect predicted layer may be defined as a layer for which another layer is an indirect reference layer. An independent layer may be defined as a layer that does not have direct reference layers. In other words, an independent layer is not predicted using inter-layer prediction. A non-base layer may be defined as any other layer than the base layer, and the base layer may be defined as the lowest layer in the bitstream. An independent non-base layer may be defined as a layer that is both an independent layer and a non-base layer.

A source picture for inter-layer prediction may be defined as a decoded picture that either is, or is used in deriving, an inter-layer reference picture that may be used as a reference picture for prediction of the current picture. In multi-layer HEVC extensions, an inter-layer reference picture is included in an inter-layer reference picture set of the current picture. An inter-layer reference picture may be defined as a reference picture that may be used for inter-layer prediction of the current picture. In the coding and/or decoding process, the inter-layer reference pictures may be treated as long term reference pictures. A reference-layer picture may be defined as a picture in a direct reference layer of a particular layer or a particular picture, such as the current layer or the current picture (being encoded or decoded). A reference-layer picture may but need not be used as a source picture for inter-layer prediction. Sometimes, the terms reference-layer picture and source picture for inter-layer prediction may be used interchangeably.

A source picture for inter-layer prediction may be required to be in the same access unit as the current picture. In some cases, e.g. when no resampling, motion field mapping or other inter-layer processing is needed, the source picture for inter-layer prediction and the respective inter-layer reference picture may be identical. In some cases, e.g. when resampling is needed to match the sampling grid of the reference layer to the sampling grid of the layer of the current picture (being encoded or decoded), inter-layer processing is applied to derive an inter-layer reference picture from the source picture for inter-layer prediction. Examples of such inter-layer processing are described in the next paragraphs.

Inter-layer sample prediction may be comprise resampling of the sample array(s) of the source picture for inter-layer prediction. The encoder and/or the decoder may derive a horizontal scale factor (e.g. stored in variable ScaleFactorX) and a vertical scale factor (e.g. stored in variable ScaleFactorY) for a pair of an enhancement layer and its reference layer for example based on the reference layer location offsets for the pair. If either or both scale factors are not equal to 1, the source picture for inter-layer prediction may be resampled to generate an inter-layer reference picture for predicting the enhancement layer picture. The process and/or the filter used for resampling may be pre-defined for example in a coding standard and/or indicated by the encoder in the bitstream (e.g. as an index among pre-defined resampling processes or filters) and/or decoded by the decoder from the bitstream. A different resampling process may be indicated by the encoder and/or decoded by the decoder and/or inferred by the encoder and/or the decoder depending on the values of the scale factor. For example, when both scale factors are less than 1, a pre-defined downsampling process may be inferred; and when both scale factors are greater than 1, a pre-defined upsampling process may be inferred. Additionally or alternatively, a different resampling process may be indicated by the encoder and/or decoded by the decoder and/or inferred by the encoder and/or the decoder depending on which sample array is processed. For example, a first resampling process may be inferred to be used for luma sample arrays and a second resampling process may be inferred to be used for chroma sample arrays.

Resampling may be performed for example picture-wise (for the entire source picture for inter-layer prediction or for the reference region of the source picture for inter-layer prediction), slice-wise (e.g. for a reference layer region corresponding to an enhancement layer slice) or block-wise (e.g. for a reference layer region corresponding to an enhancement layer coding tree unit). The resampling of the determined region (e.g. a picture, slice, or coding tree unit in an enhancement layer picture) may for example be performed by looping over all sample positions of the determined region and performing a sample-wise resampling process for each sample position. However, it is to be understood that other possibilities for resampling a determined region exist—for example, the filtering of a certain sample location may use variable values of the previous sample location.

SHVC enables the use of weighted prediction or a color-mapping process based on a 3D lookup table (LUT) for (but not limited to) color gamut scalability. The 3D LUT approach may be described as follows. The sample value range of each color components may be first split into two ranges, forming up to 2×2×2 octants, and then the luma ranges can be further split up to four parts, resulting into up to 8×2×2 octants. Within each octant, a cross color component linear model is applied to perform color mapping. For each octant, four vertices are encoded into and/or decoded from the bitstream to represent a linear model within the octant. The color-mapping table is encoded into and/or decoded from the bitstream separately for each color component. Color mapping may be considered to involve three steps: First, the octant to which a given reference-layer sample triplet (Y, Cb, Cr) belongs is determined. Second, the sample locations of luma and chroma may be aligned through applying a color component adjustment process. Third, the linear mapping specified for the determined octant is applied. The mapping may have cross-component nature, i.e. an input value of one color component may affect the mapped value of another color component. Additionally, if inter-layer resampling is also required, the input to the resampling process is the picture that has been color-mapped. The color-mapping may (but needs not to) map samples of a first bit-depth to samples of another bit-depth.

In MV-HEVC, SMV-HEVC, and reference index based SHVC solution, the block level syntax and decoding process are not changed for supporting inter-layer texture prediction. Only the high-level syntax has been modified (compared to that of HEVC) so that reconstructed pictures (upsampled if necessary) from a reference layer of the same access unit can be used as the reference pictures for coding the current enhancement layer picture. The inter-layer reference pictures as well as the temporal reference pictures are included in the reference picture lists. The signalled reference picture index is used to indicate whether the current Prediction Unit (PU) is predicted from a temporal reference picture or an inter-layer reference picture. The use of this feature may be controlled by the encoder and indicated in the bitstream for example in a video parameter set, a sequence parameter set, a picture parameter, and/or a slice header. The indication(s) may be specific to an enhancement layer, a reference layer, a pair of an enhancement layer and a reference layer, specific Temporalld values, specific picture types (e.g. RAP pictures), specific slice types (e.g. P and B slices but not I slices), pictures of a specific POC value, and/or specific access units, for example. The scope and/or persistence of the indication(s) may be indicated along with the indication(s) themselves and/or may be inferred.

The reference list(s) in MV-HEVC, SMV-HEVC, and a reference index based SHVC solution may be initialized using a specific process in which the inter-layer reference picture(s), if any, may be included in the initial reference picture list(s). are constructed as follows. For example, the temporal references may be firstly added into the reference lists (L0, L1) in the same manner as the reference list construction in HEVC. After that, the inter-layer references may be added after the temporal references. The inter-layer reference pictures may be for example concluded from the layer dependency information, such as the RefLayerId[i] variable derived from the VPS extension as described above. The inter-layer reference pictures may be added to the initial reference picture list L0 if the current enhancement-layer slice is a P Slice, and may be added to both initial reference picture lists L0 and L1 if the current enhancement-layer slice is a B Slice. The inter-layer reference pictures may be added to the reference picture lists in a specific order, which can but need not be the same for both reference picture lists. For example, an opposite order of adding inter-layer reference pictures into the initial reference picture list 1 may be used compared to that of the initial reference picture list 0. For example, inter-layer reference pictures may be inserted into the initial reference picture 0 in an ascending order of nuh_layer_id, while an opposite order may be used to initialize the initial reference picture list 1.

In the coding and/or decoding process, the inter-layer reference pictures may be treated as a long term reference pictures.

Inter-layer motion prediction may be realized as follows. A temporal motion vector prediction process, such as TMVP of H.265/HEVC, may be used to exploit the redundancy of motion data between different layers. This may be done as follows: when the decoded base-layer picture is upsampled, the motion data of the base-layer picture is also mapped to the resolution of an enhancement layer. If the enhancement layer picture utilizes motion vector prediction from the base layer picture e.g. with a temporal motion vector prediction mechanism such as TMVP of H.265/HEVC, the corresponding motion vector predictor is originated from the mapped base-layer motion field. This way the correlation between the motion data of different layers may be exploited to improve the coding efficiency of a scalable video coder.

In SHVC and/or alike, inter-layer motion prediction may be performed by setting the inter-layer reference picture as the collocated reference picture for TMVP derivation. A motion field mapping process between two layers may be performed for example to avoid block level decoding process modification in TMVP derivation. The use of the motion field mapping feature may be controlled by the encoder and indicated in the bitstream for example in a video parameter set, a sequence parameter set, a picture parameter, and/or a slice header. The indication(s) may be specific to an enhancement layer, a reference layer, a pair of an enhancement layer and a reference layer, specific TemporalId values, specific picture types (e.g. RAP pictures), specific slice types (e.g. P and B slices but not I slices), pictures of a specific POC value, and/or specific access units, for example. The scope and/or persistence of the indication(s) may be indicated along with the indication(s) themselves and/or may be inferred.

In a motion field mapping process for spatial scalability, the motion field of the upsampled inter-layer reference picture may be attained based on the motion field of the respective source picture for inter-layer prediction. The motion parameters (which may e.g. include a horizontal and/or vertical motion vector value and a reference index) and/or a prediction mode for each block of the upsampled inter-layer reference picture may be derived from the corresponding motion parameters and/or prediction mode of the collocated block in the source picture for inter-layer prediction. The block size used for the derivation of the motion parameters and/or prediction mode in the upsampled inter-layer reference picture may be for example 16×16. The 16×16 block size is the same as in HEVC TMVP derivation process where compressed motion field of reference picture is used.

In some cases, data in an enhancement layer can be truncated after a certain location, or even at arbitrary positions, where each truncation position may include additional data representing increasingly enhanced visual quality. Such scalability is referred to as fine-grained (granularity) scalability (FGS).

Similarly to MVC, in MV-HEVC, inter-view reference pictures can be included in the reference picture list(s) of the current picture being coded or decoded. SHVC uses multi-loop decoding operation (unlike the SVC extension of H.264/AVC). SHVC may be considered to use a reference index based approach, i.e. an inter-layer reference picture can be included in a one or more reference picture lists of the current picture being coded or decoded (as described above).

For the enhancement layer coding, the concepts and coding tools of HEVC base layer may be used in SHVC, MV-HEVC, and/or alike. However, the additional inter-layer prediction tools, which employ already coded data (including reconstructed picture samples and motion parameters a.k.a motion information) in reference layer for efficiently coding an enhancement layer, may be integrated to SHVC, MV-HEVC, and/or alike codec.

It has been proposed that a bitstream needs not necessarily have a base layer (i.e., a layer with nuh_layer_id equal to 0 in multi-layer HEVC extensions) included in the bitstream or provided externally (in case of hybrid codec scalability), but the lowest layer may be an independent non-base layer. In some cases the layer with the lowest nuh_layer_id present in the bitstream may be regarded as the base layer of the bitstream.

In HEVC, the VPS flags vps_base_layer_internal_flag and vps_base_layer_available_flag may be used to indicate the presence and availability of the base layer as follows: If vps_base_layer_internal_flag is equal to 1 and vps_base_layer_available_flag is equal to 1, the base layer is present in the bitstream. Otherwise, if vps_base_layer_internal_flag is equal to 0 and vps_base_layer_available_flag is equal to 1, the base layer is provided by external means to the multi-layer HEVC decoding process, i.e. decoded base layer pictures as well as certain variables and syntax elements for the decoded base layer pictures are provided to the multi-layer HEVC decoding process. Otherwise, if vps_base_layer_internal_flag is equal to 1 and vps_base_layer_available_flag is equal to 0, the base layer is not available (neither present in the bitstream nor provided by external means) but the VPS includes information of the base layer as if it were present in the bitstream. Otherwise (vps_base_layer_internal_flag is equal to 0 and vps_base_layer_available_flag is equal to 0), the base layer is not available (neither present in the bitstream nor provided by external means) but the VPS includes information of the base layer as if it were provided by external means.

A coding standard may include a sub-bitstream extraction process, and such is specified for example in SVC, MVC, and HEVC. The sub-bitstream extraction process relates to converting a bitstream, typically by removing NAL units, to a sub-bitstream, which may also be referred to as a bitstream subset. The sub-bitstream still remains conforming to the standard. For example, in HEVC, the bitstream created by excluding all VCL NAL units having a TemporalId value greater than a selected value and including all other VCL NAL units remains conforming.

The HEVC standard (version 2) includes three sub-bitstream extraction processes. The sub-bitstream extraction process in clause 10 of the HEVC standard is identical to that in clause F.10.1 except that the bitstream conformance requirements for the resulting sub-bitstream are relaxed in clause F.10.1 so that it can be used also for bitstream where the base layer is external (in which case vps_base_layer_internal_flag is equal to 0) or not available (in which case vps_base_layer_available_flag is equal to 0). Clause F.10.3 of the HEVC standard (version 2) specifies a sub-bitstream extraction process resulting into a sub-bitstream that does not contain the base layer. All three sub-bitstream extraction processes operate similarly: the sub-bitstream extraction process takes a TemporalId and/or a list of nuh_layer_id values as input and derives a sub-bitstream (also known as a bitstream subset) by removing from the bitstream all NAL units with TemporalId greater than the input TemporalId value or nuh_layer_id value not among the values in the input list of nuh_layer_id values.

A coding standard or system may refer to a term operation point or alike, which may indicate the scalable layers and/or sub-layers under which the decoding operates and/or may be associated with a sub-bitstream that includes the scalable layers and/or sub-layers being decoded. In HEVC, an operation point is defined as bitstream created from another bitstream by operation of the sub-bitstream extraction process with the another bitstream, a target highest TemporalId, and a target layer identifier list as inputs.

An output layer may be defined as a layer whose decoded pictures are output by the decoding process. The output layers may depend on which subset of the multi-layer bitstream is decoded. The pictures output by the decoding process may be further processed, e.g. a color space conversion from the YUV color space to RGB may be performed, and they may be displayed. However, further processing and/or displaying may be considered to be processes external of the decoder and/or the decoding process and might not take place.

In multi-layer video bitstreams, an operation point definition may include a consideration a target output layer set. For example, an operation point may be defined as a bitstream that is created from another bitstream by operation of the sub-bitstream extraction process with the another bitstream, a target highest temporal sub-layer (e.g. a target highest TemporalId), and a target layer identifier list as inputs, and that is associated with a set of output layers. Alternatively, another term, such as an output operation point, may be used when referring to an operation point and the associated set of output layers. For example, in MV-HEVC/SHVC, an output operation point may be defined as a bitstream that is created from an input bitstream by operation of the sub-bitstream extraction process with the input bitstream, a target highest TemporalId, and a target layer identifier list as inputs, and that is associated with a set of output layers.

As scalable multi-layer bitstreams enable decoding of more than one combinations of layers and temporal sub-layers, a multi-layer decoding process may be given as input (by external means) a target output operation point. The output operation point may be provided e.g. by specifying the output layer set (OLS) and the highest temporal sub-layer to be decoded. An OLS may be defined to represent a set of layers, which may be categorized to be either necessary or unnecessary layers. A necessary layer may be defined to be either an output layer, meaning that the pictures of the layer are output by the decoding process, or a reference layer, meaning that its pictures may be directly or indirectly used as a reference for prediction of pictures of any output layer. In multi-layer HEVC extensions, the VPS includes a specification of OLSs, and can also specify buffering requirements and parameters for OLSs. Unnecessary layers may be defined as those layers that are not required to be decoded for reconstructing the output layers but can be included in OLSs for indicating buffering requirements for such sets of layers in which some layers are coded with potential future extensions.

While a constant set of output layers suits well use cases and bitstreams where the highest layer stays unchanged in each access unit, they may not support use cases where the highest layer changes from one access unit to another. It has therefore been proposed that encoders can specify the use of alternative output layers within the bitstream and in response to the specified use of alternative output layers decoders output a decoded picture from an alternative output layer in the absence of a picture in an output layer within the same access unit. Several possibilities exist how to indicate alternative output layers. For example, each output layer in an output layer set may be associated with a minimum alternative output layer, and output-layer-wise syntax element(s) may be used for specifying alternative output layer(s) for each output layer. Alternatively, the alternative output layer set mechanism may be constrained to be used only for output layer sets containing only one output layer, and output-layer-set-wise syntax element(s) may be used for specifying alternative output layer(s) for the output layer of the output layer set. Alternatively, as specified in HEVC, the alternative output layer set mechanism may be constrained to be used only for output layer sets containing only one output layer, and an output-layer-set-wise flag (alt_output_layer_flag[olsIdx] in HEVC) may be used for specifying that any direct or indirect reference layer of the output layer may serve as an alternative output layer for the output layer of the output layer set. Alternatively, the alternative output layer set mechanism may be constrained to be used only for bitstreams or CVSs in which all specified output layer sets contain only one output layer, and the alternative output layer(s) may be indicated by bitstream- or CVS-wise syntax element(s). The alternative output layer(s) may be for example specified by listing e.g. within VPS the alternative output layers (e.g. using their layer identifiers or indexes of the list of direct or indirect reference layers), indicating a minimum alternative output layer (e.g. using its layer identifier or its index within the list of direct or indirect reference layers), or a flag specifying that any direct or indirect reference layer is an alternative output layer. When more than one alternative output layer is enabled to be used, it may be specified that the first direct or indirect inter-layer reference picture present in the access unit in descending layer identifier order down to the indicated minimum alternative output layer is output.

Picture output in scalable coding may be controlled for example as follows: For each picture PicOutputFlag is first derived in the decoding process similarly as for a single-layer bitstream. For example, pic_output_flag included in the bitstream for the picture may be taken into account in the derivation of PicOutputFlag. When an access unit has been decoded, the output layers and possible alternative output layers are used to update PicOutputFlag for each picture of the access unit.

When a bitstream specifies the use of an alternative output layer mechanism, the decoding process may operate as follows when it comes to controlling decoded picture output from the decoding process. Here, it is assumed that HEVC decoding is in use and alt_output_layer_flag[TargetOlsIdx] is equal to 1, but the decoding process could be realized similarly with other codecs. When the decoding of a picture is completed, the variable PicOutputFlag for the picture may be set as follows:
If LayerinitializedFlag[nuh_layer_id] is equal to 0, PicOutputFlag is set equal to 0.
Otherwise, if the current picture is a RASL picture and NoRaslOutputFlag of the associated TRAP picture is equal to 1, PicOutputFlag is set equal to 0.
Otherwise, PicOutputFlag is set equal to pic_output_flag, where pic_output_flag is a syntax element associated with the picture, e.g. carried in the slice header of the coded slices of the picture.
   Additionally, when the decoding of the last picture of an access unit is completed, PicOutputFlag of each decoded picture of the access unit may be updated as follows (prior to the decoding of the next picture):
If alt_output_layer_flag[TargetOlsIdx] is equal to 1 and the current access unit either does not contain a picture at the output layer or contains a picture at the output layer that has PicOutputFlag equal to 0, the following ordered steps apply:
   The list nonOutputLayerPictures is set to be the list of the pictures of the access unit with PicOutputFlag equal to 1 and with nuh_layer_id values among the nuh_layer_id values of the reference layers of the output layer.
   When the list nonOutputLayerPictures is not empty, the picture with the highest nuh_layer_id value among the list nonOutputLayerPictures is removed from the list nonOutputLayerPictures.
   PicOutputFlag for each picture that is included in the list nonOutputLayerPictures is set equal to 0.
Otherwise, PicOutputFlag for pictures that are not included in an output layer is set equal to 0.

As described in the previous paragraph, when the alternative output layer mechanism is in use, the decoding of an access unit may need to be completed before it can be determined which decoded picture(s) of the access unit are output by the decoding process.

Skip coding of a block, a region, or a picture may be defined in the context of scalable video coding so that the decoded or reconstructed block, region, or picture, respectively, is identical to the inter-layer prediction signal (e.g. the respective block, region, or picture, respectively, of the inter-layer reference picture in case of uni-prediction). No prediction error is coded for a skip coded block, region, or picture, and consequently no prediction error is decoded for a skip coded block, region, or picture. It may be indicated by an encoder and/or decoded by a decoder e.g. block-wise (e.g. using the cu_skip_flag of HEVC or alike) that coded prediction error is not available. It may be pre-defined e.g. in a coding standard, or it may indicated by an encoder and decoded by a decoder that in-loop filtering is turned off for the skip coded block, region, or picture. It may be pre-defined e.g. in a coding standard, or it may indicated by an encoder and decoded by a decoder that weighted prediction is turned off.

A profile may be defined as a subset of the entire bitstream syntax that is specified by a decoding/coding standard or specification. Within the bounds imposed by the syntax of a given profile it is still possible to require a very large variation in the performance of encoders and decoders depending upon the values taken by syntax elements in the bitstream such as the specified size of the decoded pictures. In many applications, it might be neither practical nor economic to implement a decoder capable of dealing with all hypothetical uses of the syntax within a particular profile. In order to deal with this issue, levels may be used. A level may be defined as a specified set of constraints imposed on values of the syntax elements in the bitstream and variables specified in a decoding/coding standard or specification. These constraints may be simple limits on values. Alternatively or in addition, they may take the form of constraints on arithmetic combinations of values (e.g., picture width multiplied by picture height multiplied by number of pictures decoded per second). Other means for specifying constraints for levels may also be used. Some of the constraints specified in a level may for example relate to the maximum picture size, maximum bitrate and maximum data rate in terms of coding units, such as macroblocks, per a time period, such as a second. The same set of levels may be defined for all profiles. It may be preferable for example to increase interoperability of terminals implementing different profiles that most or all aspects of the definition of each level may be common across different profiles. A tier may be defined as specified category of level constraints imposed on values of the syntax elements in the bitstream, where the level constraints are nested within a tier and a decoder conforming to a certain tier and level would be capable of decoding all bitstreams that conform to the same tier or the lower tier of that level or any level below it.

While many earlier video coding standards specified profile-level conformance points applying to a bitstream, multi-layer HEVC extensions specify layer-wise conformance points. To be more exact, a profile-tier-level (PTL) combination is indicated for each necessary layer of each OLS, while even finer-grain temporal-sub-layer-based PTL signaling is allowed, i.e. it is possible to indicate a PTL combination for each temporal subset of each necessary layer of each OLS. Decoder capabilities of HEVC decoders can be indicated as a list of PTL values, where the number of list elements indicates the number of layers supported by the decoder and each PTL value indicates the decoding capability for a layer. Non-base layers that are not inter-layer predicted can be indicated to conform to a single-layer profile, such as the Main profile, while they also require so-called independent non-base layer decoding (INBLD) capability to deal correctly with layer-wise decoding.

There is an inevitable trend of increasing picture rates in consumer and professional video. For example, consumer products, such as digital still cameras, smartphone cameras, and action cameras, are able to capture video at high picture rates, such as 120 Hz or 240 Hz, and today's television sets are capable of displaying picture rates of hundreds of Hz.

In many applications, it is beneficial that the picture rate can be selected by the decoder or player according to its capabilities. For example, even if a bitstream providing 120-Hz picture rate is provided to the player, it could be beneficial that e.g. a 30-Hz version could be decoded if such better suits e.g. the available computational resources, the available battery charging level, and/or the display capabilities. Such scaling can be achieved by applying temporal scalability in video encoding and decoding.

The temporal scalability may involve a problem that video captured with short exposure times (e.g. for 240 Hz) may look unnatural when it is temporally subsampled to be played at 30 Hz due to the lacking motion blur. Temporal scalability and exposure time scaling may be considered to involve two cases: in the first case, the exposure time at the lower frame is the kept the same as that at the higher frame rate, wherein any issues relating to motion blur can be handled by a decoder in a rather straightforward way. In the second case, the exposure time at different frame rates may be different, which may result in a rather complex issue to handle.

A high-level-syntax-only (HLS-only) design principle was chosen for SHVC and MV-HEVC, meaning that there are no changes to the HEVC syntax or decoding process below the slice header. Consequently, the HEVC encoder and decoder implementations can be largely re-used for SHVC and MV-HEVC. For SHVC, a concept known as inter-layer processing is used, which is used to resample the decoded reference layer picture and its motion vector array, if needed, and/or to apply color mapping (e.g. for color gamut scaling).

Similarly to inter-layer processing, picture rate upsampling (a.k.a. frame rate upsampling) methods are applied as post-processing to decoding. In other words, pictures generated by a picture rate upsampling algorithm are not used as reference pictures in the encoding or decoding. Nevertheless, using the upsampled pictures as reference pictures in the encoding or decoding could offer opportunities for enhancing the compression efficiency of temporally scalable bitstreams.

Considering the HLS-only design of many contemporary video coding standards, there is a need to improve the compression efficiency of temporally scalable bitstreams in a manner that existing implementations (e.g. HEVC, SHVC) can be re-used.

Now in order to enhance the compression efficiency of temporally scalable bitstreams, an improved method for video coding is presented hereinafter. Unless defined otherwise in specific embodiments, the term coded base picture may be defined as a direct reference layer picture, the term reconstructed base picture may be defined as source picture for inter-layer prediction, the term coded enhancement picture may be defined as a coded picture in a predicted layer, and the term reconstructed enhancement picture may be defined as a decoded picture of a predicted layer.

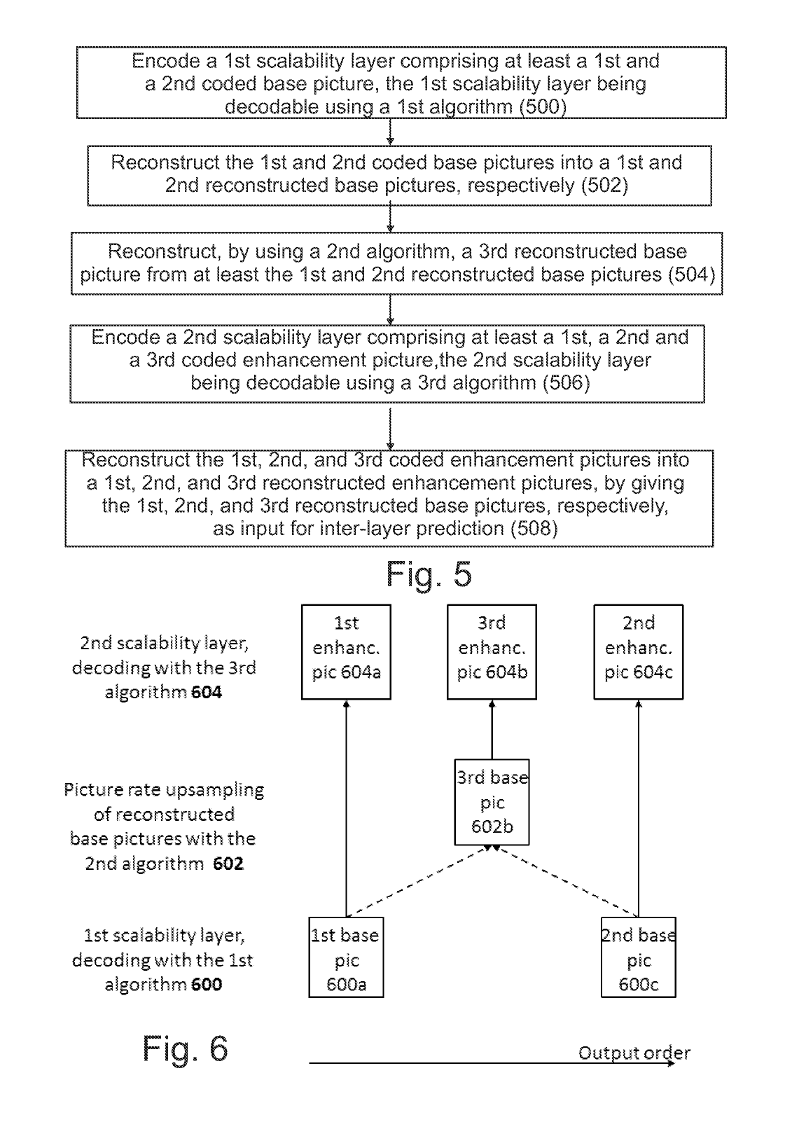

In the method, which is disclosed in FIG. 5, a first scalability layer is encoded (500), the first scalability layer comprising at least a first coded base picture and a second coded base picture, and the first scalability layer being decodable using a first algorithm. The method further comprises reconstructing (502) the first and second coded base pictures into a first and second reconstructed base pictures, respectively, the first reconstructed base picture and the second reconstructed base picture being adjacent in output order of the first algorithm among all reconstructed pictures of the first scalability layer; reconstructing (504), by using a second algorithm, a third reconstructed base picture from at least the first and second reconstructed base pictures, the third reconstructed base picture residing between the first reconstructed base picture and the second reconstructed base picture in output order; encoding (506) a second scalability layer comprising at least a first coded enhancement picture, a second coded enhancement picture and a third coded enhancement picture, the second scalability layer being decodable using a third algorithm comprising inter-layer prediction that takes a reconstructed picture as input; and reconstructing (508) the first, second, and third coded enhancement pictures into a first, second, and third reconstructed enhancement pictures, respectively, by giving the first, second, and third reconstructed base pictures, respectively, as input for inter-layer prediction, the first, second, and third reconstructed enhancement picture matching in output order of the first algorithm with the first, second, and third reconstructed base pictures, respectively.

In other words, there is provided a mechanism for increasing the picture rate of a base layer conforming to an existing format, such as HEVC, in a manner that the enhancement layer (corresponding to the increased picture rate) also conforms to an existing format, such as SHVC.

According to an embodiment, said second and said third algorithms are motion-compensated prediction algorithms, and said second algorithm differs from the first and the third algorithm. Thus, for the picture rate upsampling, the method enables the use of a second motion-compensated prediction algorithm (i.e. said second algorithm) that differs from a first motion-compensated prediction algorithm (i.e. said third algorithm) included e.g. in HEVC or SHVC. The use between the first and second motion-compensated prediction (or using another prediction, such as intra prediction) for increasing the picture rate can be block-wise dynamically selected by the encoder and indicated in the bitstream, and hence said dynamic selection of between the first and second motion compensated prediction is also followed by the decoder.

As the second motion-compensated prediction algorithm can in many cases provide more accurate prediction signal than the first-motion compensated prediction, the presented mechanism can improve compression efficiency. Thanks to the capability of block-wise dynamic selection between the first and second motion-compensated prediction and possible other predictions (such as intra prediction), the second motion-compensated prediction algorithm does not need to perform better than other prediction methods for all blocks, and hence the proposed mechanism operates better than or at least equally to prior-art methods for any types of content.

FIG. 6 illustrates a generalized principle of the mechanism according to an embodiment. The mechanism shown in FIG. 6 applies to both encoding and decoding. The first scalability layer 600 is encoded or decoded e.g. with HEVC encoder or decoder. The first scalability layer 600 has a lower picture rate than the second scalability layer 604. A picture rate upsampling algorithm (i.e. the second algorithm) is applied to the reconstructed or decoded pictures 600a, 600c of the first scalability layer to reconstruct a third reconstructed base picture 602b. Herein, the letter a, b, c, . . . refers to the output order of the pictures. The picture rate upsampling method may additionally utilize coded data of the first scalability layer, such as motion vectors. Furthermore, additional data to tune the picture rate upsampling method may be encoded or decoded. The second scalability layer 604 is encoded or decoded e.g with SHVC encoder or decoder. The encoding or decoding of the second scalability layer takes reconstructed base pictures 600a, 600c, 602b as input for inter-layer prediction. The reconstructed base pictures 600a, 600c, 602b may be for example treated as external base layer pictures for the encoding or decoding of the second scalability layer. In SHVC, this can be achieved by encoding the second scalability layer into or decoding the second scalability layer from an SHVC bitstream that uses an external base layer (i.e. has vps_base_layer_internal_flag equal to 0). For the picture 604b of the second scalability layer 604 that does not have a corresponding picture in the first scalability layer (e.g. in terms of output time correspondence), the picture 602b reconstructed with the picture rate upsampling method is used as the reconstructed base pictures taken as input for inter-layer prediction. It is noted that inter prediction may be used within the first scalability layer 600 and/or within the second scalability layer 604 in FIG. 6, as well as in subsequent Figures of the application, but such inter prediction is not illustrated in the Figures.

According to an embodiment, the mechanism is used for the sole purpose of increasing picture rate such that the base pictures in the first scalability layer are not enhanced. This can be realized in various ways, including but not limited to the following:

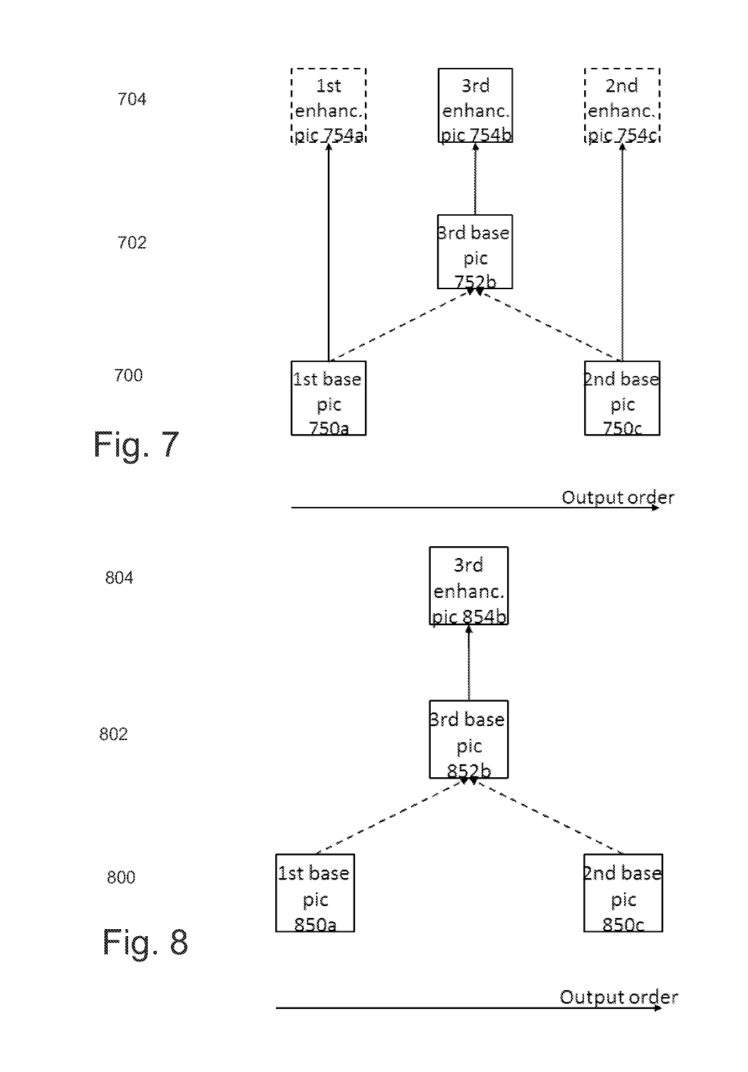

According to an embodiment, which is illustrated in FIG. 7, the encoder operates as described above for FIG. 6 except that pictures 754a and 754c are coded differently from pictures 604a and 604c, respectively, as described in the following. The encoder encodes the second scalability layer 754 in a manner that the pictures corresponding to the pictures of the first scalability layer 750 (e.g. in terms of the output time correspondence) are skip coded. In FIG. 7, each box with dashed outline indicates a skip coded picture (754a, 754c). According to an embodiment, the encoder includes an indication associated with the second scalability layer that those pictures (754a, 754c) of the second scalability layer that correspond to the pictures of the first scalability layer (750a, 750c). are skip coded. According to an embodiment, the decoder operates as described above for FIG. 6 except that pictures 754a and 754c are decoded differently from pictures 604a and 604c, respectively, as described in the following. The decoder decodes said indication associated with the second scalability layer and omits the decoding of the pictures of the second scalability layer that correspond to the pictures of the first scalability layer and instead outputs the decoded pictures of the first scalability layer.

According to another embodiment, which is illustrated in FIG. 8, the encoder operates as described above for FIG. 6 except that the encoder encodes the second scalability layer 854 in a manner that no pictures are encoded corresponding to the pictures of the first scalability layer 850 (e.g. in terms of the output time correspondence). For example, when a bitstream comprises both the first 850 and second 854 scalability layers, the encoder can encode an access unit that contains only a coded picture of the first scalability layer (e.g. 850a) and no picture of the second scalability layer. In another example, when a bitstream comprises the second scalability layer 854 but not the first scalability layer 850, the encoder can encode an access unit where the picture at the second scalability layer is implicitly or explicitly indicated to be absent, e.g. by coding an access unit delimiter or alike and/or a coded unit completion indicator for an access unit or alike but including no coded picture of the second scalability layer within the access unit indicated by the access unit delimiter or alike and/or the coded unit completion indicator or alike. According to an embodiment, the encoder uses the alternative output layer mechanism, described earlier, to indicate that in the absence of a picture in the second scalability layer (e.g. in an access unit), the corresponding picture of the first scalability layer (e.g. 850a) is to be output. According to an embodiment, the decoder operates as described above for FIG. 6 except that it identifies the absence of pictures of the second scalability layer 854 in the access units comprising the first base picture 850a or the second base picture 850c and as response to this absence outputs the reconstructed base pictures 850a and 850c. According to an embodiment, the decoder operates as described above for FIG. 6 except that it identifies the absence of pictures of the second scalability layer 854 in the access units comprising the first base picture 850a or the second base picture 850c, identifies if the alternative output layer is in use (e.g. from a signaling described earlier), and, as response to this absence as well as the use of the alternative output layer, outputs the reconstructed base pictures 850a and 850c.

According to an embodiment, the mechanism is used for the purpose of increasing picture rate such that the base pictures in the first scalability layer are modified. The modification may be, for example, caused by a fact that a first video sequence represented by the first scalability layer may have been captured using a first exposure time for picture acquisition that is longer than a second exposure time that was used to capture a second video sequence represented by the second scalability layer. Consequently, even if the first and second video sequences originate from the same camera, the individual pictures may have different properties, e.g. pictures of the first video sequence may comprise more motion blurring. The modification may aim at making the reconstructed second scalability layer to have subjectively steady quality and/or to provide suitable inputs for picture rate upsampling, and hence improve the fidelity of the pictures generated by the picture rate upsampling and consequently improve compression. This embodiment, too, may be realized in several ways including but not limited to the following:

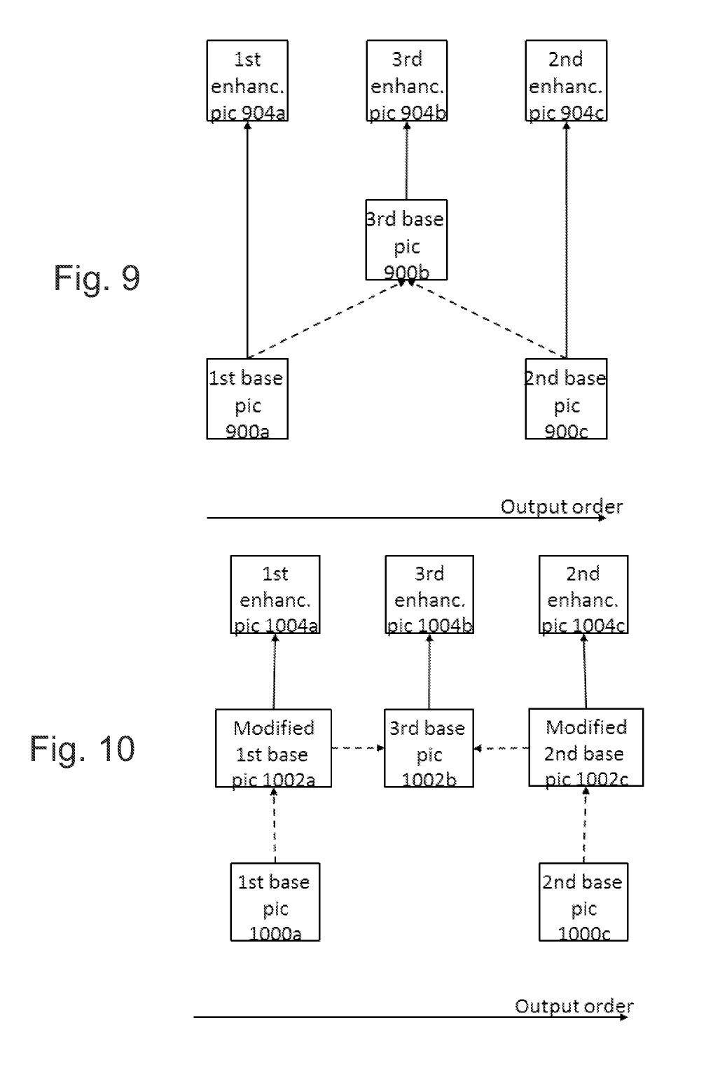

According to an embodiment, which is illustrated in FIG. 9, the reconstructed base pictures 900a, 900c are used as input to reconstruct a picture rate upsampling picture 902b (prior to their modification). The reconstructed base pictures 900a, 900c, 902b are then modified e.g. by using the corresponding pictures 904a, 904b, 904c of the second enhancement layer. This embodiment may be applied in an encoder and/or in a decoder. The encoder and/or the decoder of this embodiment may otherwise operate as described for FIG. 6.

According to another embodiment, which is illustrated in FIG. 10, the reconstructed base pictures 1000a, 1000c are first modified e.g. by using a deblurring algorithm. Any deblurring algorithm may be used herein and subsequently when referring to deblurring. In some embodiments, the deblurring algorithm is pre-defined e.g. in a coding standard. In some embodiments, more than one deblurring algorithm is pre-defined e.g. in a coding standard, and an encoder indicates in a bitstream and/or a decoder decodes from the bitstream which one of them is in use. The deblurring algorithm may aim at removing, reducing and/or concealing motion blur. The modified base pictures 1002a, 1002c are used as input to reconstruct a picture rate upsampling picture 1002b. The modified base pictures 1002a, 1002b, 1002c may also be used as a reference for inter-layer prediction of the corresponding pictures 1004a, 1004b, 1004c in the second scalability layer. This embodiment may be applied in an encoder and/or in a decoder. The encoder and/or the decoder of this embodiment may otherwise operate as described for FIG. 6.

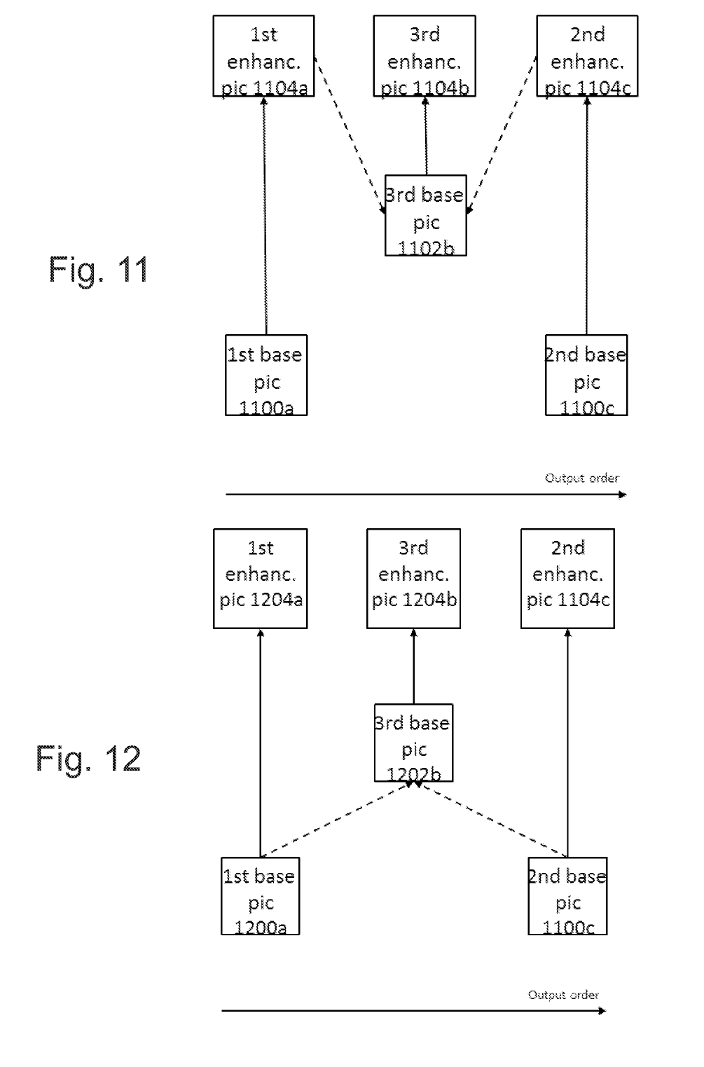

According to yet another embodiment, which is illustrated in FIG. 11, the reconstructed base pictures 1100a, 1100c are first modified by using the corresponding pictures 1104a, 1104c of the second enhancement layer. Such modification may use an existing algorithm, such as SHVC, or it may use or partly involve a new algorithm. The reconstructed pictures 1104a, 1104c of the second enhancement layer are used as input to reconstruct a picture rate upsampling picture 1102b. This embodiment may be applied in an encoder and/or in a decoder. The encoder and/or the decoder of this embodiment may otherwise operate as described for FIG. 6.

According to an embodiment, the encoder indicates in the bitstream e.g. in a sequence-level syntax structure such as VPS which realization e.g. from the list of above embodiments is in use. The decoder decodes from the bitstream e.g. from a sequence-level syntax structure such as VPS which realization e.g. from the list of above embodiments is in use.

According to an embodiment, the mechanism is used for the purpose of increasing picture rate as well as any other type or types of enhancements, such as signal-to-noise (a.k.a. picture quality, a.k.a. picture fidelity) enhancement, spatial enhancement, sample bit-depth increase, dynamic range increase, and/or broadening the color gamut.

The second scalability layer is coded or decoded with suitable types of scalability enabled, such as SNR, spatial, bit-depth, dynamic range, and/or color gamut scalability. The reconstructed base pictures may undergo inter-layer processing, such as resampling, bit-depth increase, and/or color mapping, prior to their use as reference pictures for the second scalability layer. The picture rate upsampling and, in some embodiments, the modification of the reconstructed base pictures (e.g. deblurring) may be considered as parts of said inter-layer processing or may precede said inter-layer processing. When it comes to handling of the base pictures prior to said inter-layer processing, the embodiment may be used with any realization of the above embodiments relating to increasing picture rate such that the base pictures in the first scalability layer are modified. Thus, the embodiment may therefore be realized in various ways, including but not limited to the following:

According to an embodiment, which is illustrated in FIG. 12, the reconstructed base pictures 1200a, 1200c are used as input to reconstruct a picture rate upsampling picture 1202b prior to their enhancement using the corresponding pictures 1204a, 1204b, 1204c in the second scalability layer. The enhancement enhances the base pictures e.g. in terms of SNR, resolution, sample bit depth, dynamic range, and/or color gamut. The enhancement may also include modification of the virtual expose time of the base pictures, e.g. reducing the amount of motion blur. This embodiment may be applied in an encoder and/or in a decoder. The encoder and/or the decoder of this embodiment may otherwise operate as described for FIG. 6.

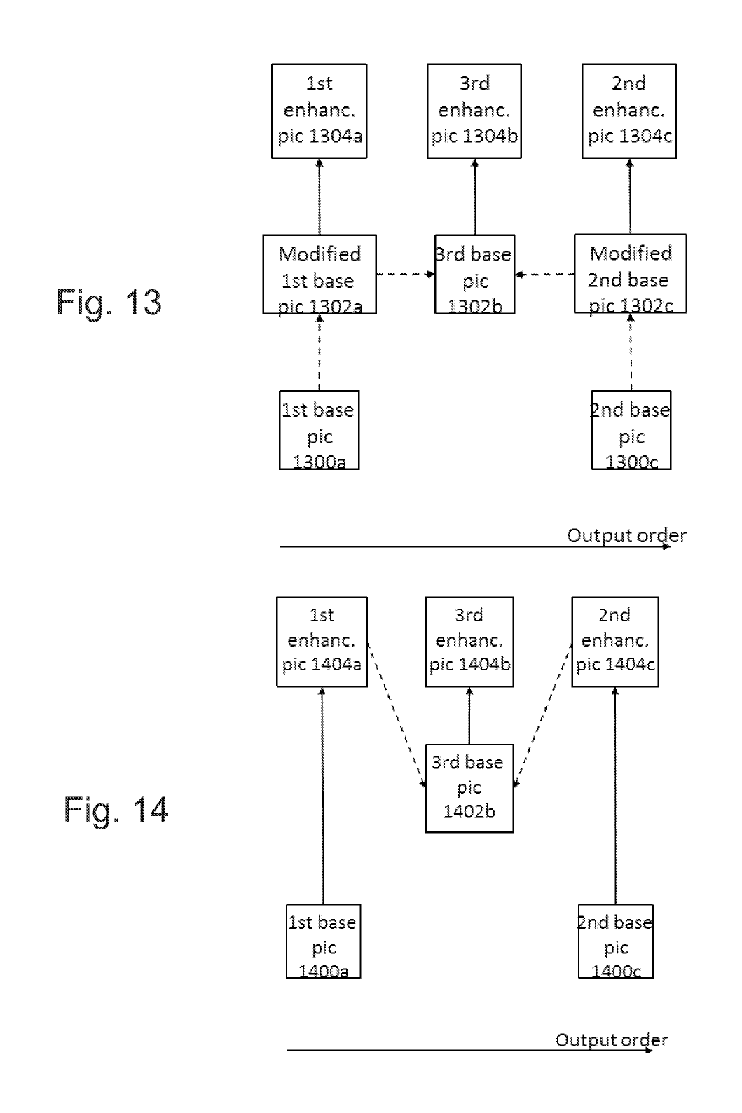

According to another embodiment, which is illustrated in FIG. 13, the reconstructed base pictures 1300a, 1300c are first modified e.g. by using a deblurring algorithm. The modified base pictures 1302a, 1302c are used as input to reconstruct a picture rate upsampling picture 1302b. The modified base pictures 1302a, 1302b, 1302c may also be used as a reference for inter-layer prediction of the corresponding pictures 1304a, 1304b, 1304c in the second scalability layer. This embodiment may be applied in an encoder and/or in a decoder. The encoder and/or the decoder of this embodiment may otherwise operate as described for FIG. 6.

According to yet another embodiment, which is illustrated in FIG. 14, the reconstructed base pictures 1400a, 1400c are first modified by using the corresponding pictures 1404a, 1404c of the second enhancement layer. Such modification may use an existing algorithm, such as SHVC, or it may use or partly involve a new algorithm. The modification enhances the base pictures e.g. in terms of SNR, resolution, sample bit depth, dynamic range, and/or color gamut. The modification may also include modification of the virtual expose time of the base pictures, e.g. reducing the amount of motion blur. The reconstructed pictures 1404a, 1404c of the second enhancement layer are used as input to reconstruct a picture rate upsampling picture 1402b. This embodiment may be applied in an encoder and/or in a decoder. The encoder and/or the decoder of this embodiment may otherwise operate as described for FIG. 6.

Using a Single Bitstream

According to an embodiment, which is applicable for encoding or decoding, the bitstream being encoded or decoded is characterized as follows:
The first and second scalability layers are in the same bitstream.
The third enhancement picture is in a higher temporal sub-layer than the first and second base and enhancement pictures.

The labeling of bitstream subsets to coding profiles may be indicated by the encoder or decoded by the decoder to be as follows:
The bitstream subset comprising the first and second base pictures and no pictures from the second scalability layer may be labeled with a first coding profile, such as the Main profile of HEVC.
The bitstream subset comprising the first and second enhancement pictures but not the third enhancement picture may be labeled with a second coding profile (different from the first coding profile), such as the Scalable Main profile of HEVC.
The bitstream subset comprising the first, second, and third enhancement pictures may be labeled with a third coding profile, herein called Scalable High profile, which is different from the first and second coding profiles.

In case of HEVC, the term bitstream subset above may be interpreted to mean an output operation point (as defined in the HEVC specification).

This embodiment may be used together with the embodiments for
increasing picture rate such that the base pictures in the first scalability layer are not enhanced according to the embodiments described in FIGS. 7 and 8,
increasing picture rate such that the base pictures in the first scalability layer are modified according to the embodiments described in FIGS. 9 and 11,
increasing picture rate as well as any other types of enhancements according to the embodiments described in FIGS. 12 and 14.

The inter-layer processing of the Scalable High profile includes the second algorithm for picture rate upsampling. In the embodiments for increasing picture rate such that the base pictures in the first scalability layer are modified and for increasing picture rate as well as any other types of enhancements, the inter-layer processing may include modification of the base pictures, e.g. for reducing motion blur, as described earlier. In the embodiment for increasing picture rate as well as any other types of enhancements, the inter-layer processing of the Scalable High profile may include other inter-layer processing, such as resampling, bit depth increase, and/or color mapping.

Using Two Bitstreams without External Inter-Layer Processing

According to an embodiment, which is applicable for encoding or decoding, the bitstreams being encoded or decoded are characterized as follows:
The first scalability layer is in a first bitstream and the second scalability layer is in a second bitstream that is different from the first bitstream
The third enhancement picture is in a higher temporal sub-layer than the first and second enhancement pictures.

The labeling of bitstreams and bitstream subsets to coding profiles may be indicated by the encoder or decoded by the decoder to be as follows:
The first bitstream (and hence the first scalability layer) may be labeled with a first coding profile, such as the Main profile of HEVC.
The second bitstream may be indicated to use an external base layer (e.g. using the vps_base_layer_internal_flag of HEVC being equal to 0).
The bitstream subset comprising the first and second enhancement pictures but not the third enhancement picture may be labeled with a second coding profile (different from the first coding profile), such as the Scalable Main profile of HEVC.
The second bitstream or equivalently the bitstream subset comprising the first, second, and third enhancement pictures may be labeled with a third coding profile (different from the first and second coding profiles), herein called Scalable High profile.

This embodiment may be used together with the embodiments for
increasing picture rate such that the base pictures in the first scalability layer are modified according to the embodiments described in FIG. 11,
increasing picture rate as well as any other types of enhancements according to the embodiments described in FIG. 14.

The inter-layer processing of the Scalable High profile includes the second algorithm (for picture rate upsampling, used in the absence of an external base picture corresponding to an enhancement picture). The inter-layer processing may include modification of the base pictures, e.g. for reducing motion blur, as described earlier. In the embodiment for increasing picture rate as well as any other types of enhancements, the inter-layer processing of the Scalable High profile may include other inter-layer processing, such as resampling, bit depth increase, and/or color mapping.

Using Two Bitstreams with External Inter-Layer Processing

According to an embodiment, which is applicable for encoding or decoding, the bitstreams being encoded or decoded is characterized as follows:
The first scalability layer is in a first bitstream and the second scalability layer is in a second bitstream that is different from the first bitstream
The third enhancement picture can but needs not be in a higher temporal sub-layer than the first and second enhancement pictures.

The picture rate upsampling and, in some realizations, the modification of the base pictures (e.g. for reducing the motion blur) are performed with inter-layer processing that is separate from the decoding of the first bitstream and the second bitstream.

The encoder, file generator, packetizer, or such may indicate with an indication separately from the first and second bitstreams but associated with either or both of the first and second bitstream that external inter-layer processing is to be used. Similarly, the decoder, file parser, depacketizer, or such may parse an indication separately from the first and second bitstreams but associated with either or both of the first and second bitstream that external inter-layer processing is to be used. The indication may for example be a part of the file encapsulating the first and second bitstream, a part of a description, such as a streaming manifest (e.g. the MPD of DASH) or session description (e.g. using SDP), and/or a part of a packet format, such as RTP payload format that external inter-layer processing is to be used. The indication may additionally identify the type of inter-layer processing to be used and/or the parameter values used as input for the inter-layer processing, such as filter kernel values for a deblurring filter. As response to parsing the indication, the decoder, file parser, depacketizer, or such, or any of their combination may perform the indicated inter-layer processing to reconstruct reconstructed pictures of the third scalability layer (illustrated in several example Figures, such as FIG. 6).

This embodiment may be used together with the embodiments for
increasing picture rate such that the base pictures in the first scalability layer are not enhanced according to the embodiments described in FIGS. 7 and 8,
increasing picture rate such that the base pictures in the first scalability layer are modified according to the embodiments described in FIGS. 9 and 10,
increasing picture rate as well as any other types of enhancements according to the embodiments described in FIGS. 12 and 13.

Third Base Picture in the First Scalability Layer

Several embodiments have been described above for reconstructing a third base picture in an inter-layer process, e.g. as described related to FIGS. 6, 7, 8, 9, 11, 12, 13, and 14. It needs to be understood that these embodiments can be similarly realized when a third (coded) base picture is included in a third scalability layer, wherein the third (coded) base picture may for example include parameter values for a picture rate upsampling algorithm, and the third coded base picture corresponds to the third reconstructed base picture. It needs to be understood also that embodiments corresponding to the set of embodiments for FIGS. 6, 7, 8, 9, 11, 12, 13, and 14 and other embodiments where any embodiment of the set can be applied can be applied when the third base picture is a part of the first scalability layer. The third base picture may be indicated by an encoder and/or decoded by a decoder to reside in a higher temporal sub-layer than the first and second base pictures. A first profile may be indicated by an encoder and decoded by a decoder to apply for the bitstream subset comprising the first and second base pictures (e.g. their temporal sub-layer) but not the third base picture, and a second profile, different from the first profile, may be indicated by an encoder and decoded by a decoder to apply for the bitstream subset comprising the third base picture in addition to the first and second base pictures.

Scalable Base Coding

According to an embodiment, the mechanism is used for the purpose of increasing picture rate as well as any other type or types of enhancements, such as signal-to-noise (a.k.a. picture quality, a.k.a. picture fidelity) enhancement, spatial enhancement, sample bit-depth increase, dynamic range increase, and/or broadening the color gamut. The enhancements other than the picture rate upsampling are performed prior to the picture rate upsampling. Scalable coding, such as SHVC, may be used for said enhancements. In other words, a bitstream may be encoded or decoded, where a base layer is enhanced e.g. in terms of SNR, resolution, sample bit-depth, dynamic range, and/or color gamut with a predicted layer.

This embodiment may be used together with the embodiments for
increasing picture rate such that the base pictures in the first scalability layer are not enhanced according to the embodiments described in FIGS. 7 and 8,
increasing picture rate such that the base pictures in the first scalability layer are modified according to the embodiments described in FIGS. 9, 10 and 11.

When interpreting the description of these realizations in the context of the present embodiment, the reconstructed base picture can be understood to be the reconstructed picture of the predicted layer, while the coded base picture can be understood to comprise both the picture of the base layer and the corresponding picture of the predicted layer. It needs to be understood that this embodiment is not limited to one predicted layer but more than one predicted layer may similarly be used.

Picture Rate Upsampling as a Scalability Layer

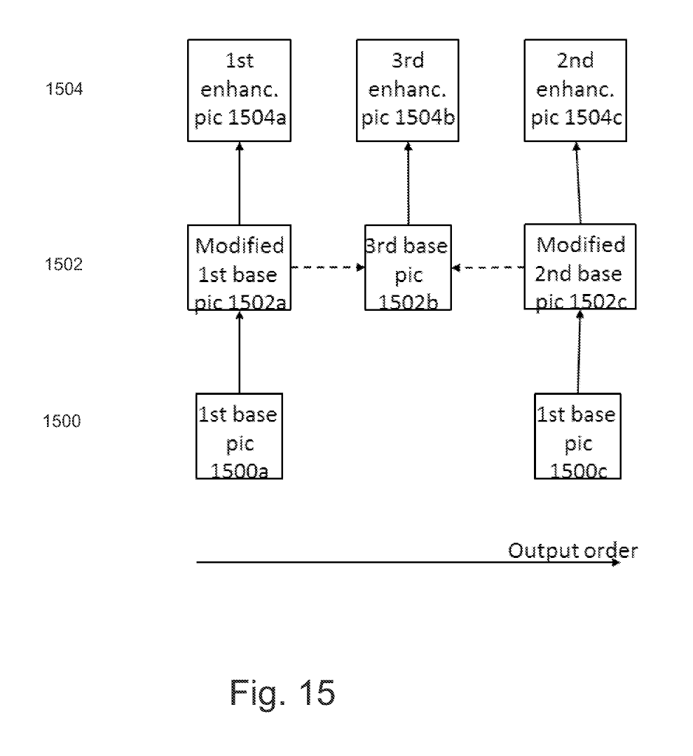

According to an embodiment, the picture rate upsampling and, in some realizations, the modification of the base pictures (e.g. for reducing motion blur) are represented as a third scalability layer, as illustrated in FIG. 15. The coded pictures of the third scalability layer 1502 may for example comprise the parameter values used for the picture rate upsampling or the modification of the base pictures. According to an embodiment, the modified first and second base pictures 1502a, 1502c are coded as skip coded pictures in the third scalability layer, while in another embodiment the modified first and second base pictures 1502a, 1502c are coded (e.g. for reducing motion blur). According to an embodiment, the first and second enhancement pictures 1504a, 1504c are coded as skip coded pictures in the second scalability layer, while in another embodiment the first and second enhancement pictures 1504a, 1504c are coded (e.g. for reducing motion blur).

According to an embodiment, the third scalability layer 1502 is in the same bitstream as the first scalability layer 1500. In another embodiment, the third scalability layer 1502 is in a different bitstream than the first scalability layer 1500, in which case the first scalability layer acts as an external base layer for the third scalability layer.

According to an embodiment, the second scalability layer 1504 is in the same bitstream as the third scalability layer 1502. In another embodiment, the second scalability layer 1504 is in a different bitstream than the third scalability layer 1502, in which case the third scalability layer acts as an external base layer for the second scalability layer.

The above-mentioned embodiments can be combined in any manner, resulting into one of the following cases:
The first, second and third scalability layers in the same bitstream.
The first scalability layer in a first bitstream and the second and third scalability layers in a second bitstream that is different from the first bitstream.
The first and third scalability layers in a first bitstream and the second scalability layer in a second bitstream that is different from the first bitstream.

According to an embodiment, the labeling of scalability layers to coding profiles may be indicated by the encoder or decoded by the decoder to be as follows:
The first scalability layer may be labeled with a first coding profile, such as the Main profile of HEVC.
The second scalability layer may be labeled with a second coding profile, such as the Scalable Main profile of HEVC.
The third scalability layer may be labeled with a third coding profile (different from the first and second coding profiles), herein called Picture Rate Enhancement profile.

According to an embodiment, the third base picture is in a higher sub-layer than the first and second modified base pictures. The labeling of bitstream subsets layers to coding profiles may be indicated by the encoder or decoded by the decoder to be as follows:
The first scalability layer may be labeled with a first coding profile, such as the Main profile of HEVC.
The second scalability layer may be labeled with a second coding profile, such as the Scalable Main profile of HEVC.
The bitstream subset comprising the first and second modified base pictures (but not the first scalability layer not the second scalability layer, and not the third base picture) may be labeled with the second coding profile, such as the Scalable Main profile of HEVC, e.g. when no inter-layer deblurring is applied, or with a third coding profile, herein called the Advanced Scalable Main profile e.g. when inter-layer deblurring is applied.
The third scalability layer (comprising the modified first and second base pictures and the third base picture) may be labeled with a fourth coding profile (different from the first and second coding profiles, and different from the third coding profile if such is used), herein called Scalable Picture Rate Enhancementprofile.

According to an embodiment, a decoder decodes the profile indication associated with the different combinations of layers and sub-layers. The decoder determines which layers and sub-layers are decoded on the basis which profiles it supports in decoding and on the dependencies between layers and sub-layers.

According to an embodiment, when a profile is associated with a set of sub-layers (from the lowest sub-layer up to any particular sub-layer) of an independent layer, the decoder determines to decode those sub-layers when it supports the profile in decoding. When a profile is associated with a set of sub-layers (from the lowest sub-layer up to any particular sub-layer) of a predicted layer, the decoder determines to decode those sub-layer when it supports the profile in decoding and also supports the profiles of the layers and sub-layers that may be directly or indirectly used as a reference for inter-layer prediction for the set of sub-layer of the predicted layer.

According to an embodiment, when a profile is associated with an independent layer (in its entirety, including all sub-layers), the decoder determines to decode the independent layer when it supports the profile in decoding. When a profile is associated with a predicted layer, the decoder determines to decode the predicted layer when it supports the profile in decoding and also supports the profiles of the layers and sub-layers that may be directly or indirectly used as a reference for inter-layer prediction for the predicted layer.

As described above in several embodiments, different bitstream subsets may be labeled to be compatible with different coding specifications and/or their profiles. The container file(s) and/or transmission can be arranged accordingly so that receivers capable of decoding some but not all the bitstream subsets can select which bitstream subsets are received and/or decapsulated (from the container file(s) and/or communication protocol(s)). For example, a different logical channel may be used for each layer or each sub-layer that causes a different profile to be used from the profile of its direct and indirect reference layers. The profile required to decoded the content of the logical channel may be signaled e.g. in a streaming manifest (e.g. MPD of MPEG-DASH) or session description (e.g. using SDP). This has the advantage that the same bitstream can be used for receivers with having capability of decoding different profiles and receivers can select a suitable bitstream subset for their use. For example, a bitstream may be contained in several tracks of one or more ISO base media file format compliant files or segments (for MPEG-DASH delivery), where each track represents to a different profile. Each track arranged this way may be announced as a Representation in an MPD of MPEG-DASH (or alike) A streaming client then selects based on its profile decoding capability which Representations (or alike) are requested, and hence subsequently received and decoded.

On Picture Rate Upsampling Methods

The methods are generally based on estimating the motion in between the first and second base pictures and performing motion-compensated blending of the first and second reconstructed base pictures. The picture rate upsampling method may hence utilize coded data of the first scalability layer, such as motion vectors. Furthermore, additional data to tune the picture rate upsampling method may be encoded or decoded.

In an example, the first and second reconstructed base pictures may be segmented to two or more segments in an encoder and/or in a decoder. For example, a foreground segment may be determined from the first and second reconstructed base pictures, and a background segment may be determined to consist of the areas outside the foreground segment. The segmentation may use for example first split the pictures into superpixels that have similar color representation. Then, superpixels that share similar motion vectors may be merged. Segmentation may also be assisted by the encoder by including parameters in the bitstream, which may be decoded by the decoder. Motion parameters, which may also be called motion hints, may be indicated by an encoder for each segment and may be decoded by a decoder. Motion parameters may for example describe an affine warping of a segment from the first reconstructed base picture to the respective segment in the second reconstructed base picture. Alternatively, motion parameters may for example describe an affine warping of a segment from the first reconstructed base picture to the respective segment in the third base picture and/or the affine warping of a segment from the second reconstructed base picture to the respective segment in the third base picture. Yet alternatively, a block-wise motion parameter field may for example be transformed, e.g. using discrete cosine transform or similar, and quantized.

In the above, example embodiments have been described through reconstructing a third base picture in its entirety. It needs to be understood that encoder and/or decoder implementations can be realized in block-wise manner. The third base picture needs not be reconstructed in its entirety but only for those parts that are used as a reference for inter-layer prediction of the third enhancement picture. For example, a decoder for the third enhancement picture may be implemented in a manner that for each block the reference picture used for predicting the block is first decoded from the bitstream. If the reference picture is an inter-layer reference picture, the second algorithm is applied to form a subset of the third reconstructed base picture that at least covers the block collocating with the block being decoded. The collocated block of the third base picture is then used as a reference for inter-layer prediction. Otherwise (the reference picture is not an inter-layer reference picture), a conventional decoding process, e.g. that of SHVC, can be used.

In the above, example embodiments have been described with picture rate upsampling taking as input two adjacent reconstructed base pictures in output order and interpolating a third base picture in output order in between the two adjacent base pictures. It needs to be understood that any embodiment above can additionally or alternatively be applied in one or more of the following cases:
extrapolating, with the second algorithm, a third base picture into an output order location either before or after the two adjacent reconstructed base pictures;
using more than two reconstructed base pictures as input for the second algorithm;
using non-adjacent reconstructed base pictures, in output order, as input for the second algorithm;
where the embodiments refer to the third base picture, they may be similarly realized with more than one additional base picture—for example, two base pictures may be generated by the second algorithm in between the first base picture and the second base picture in output order.

The above embodiments may provide various advantages. It can be assumed that the motion-compensated prediction of a picture rate upsampling can be improved at least over the inter prediction of HEVC to such an extent that clearly overcomes the overheads of multiple scalability layers and the parameters for the picture rate upsampling (as a part of the bitstream).

Moreover, existing implementations (e.g. HEVC, SHVC) can be reused. The additional parts are realized as inter-layer processing, meaning that no changes to the low-level encoding or decoding processes are required. Conventionally, introducing an additional motion model for inter prediction or an additional inter prediction mode would have required a change in the low level encoding and decoding implementation. It is therefore asserted that the invention is more straightforward to be added on top of existing codec implementations than what conventional knowledge teaches.

Furthermore, the embodiments enable hybrid codec scalability for temporal scalability for encoders or decoders that take a decoded base layer picture as input for inter-layer prediction. For example, the base layer may be coded with H.264/AVC at picture rate 30 Hz, and the enhancement layer may be coded with SHVC at picture rate 120 Hz. The decoded pictures of the base layer are used as input to picture rate upsampling, and the resulting pictures are used as the external base layer pictures for SHVC encoding/decoding.

Further, the bitstreams according to the invention remain compatible with existing codecs. In other words, it can be indicated that a subset of the bitstream can be decoded with an existing decoder (e.g. HEVC), which is also capable of omitting the coded data related to the increased picture rate.

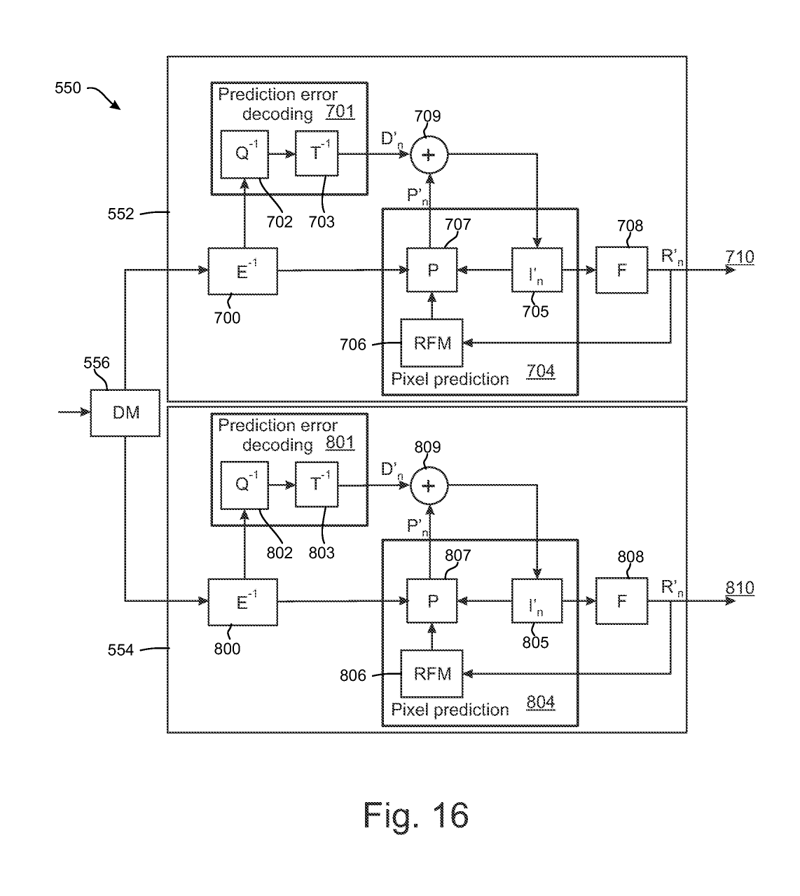

As discussed above, the embodiments described herein are equally applicable to both encoding and decoding operations. FIG. 16 shows a block diagram of a video decoder suitable for employing embodiments of the invention. FIG. 16 depicts a structure of a two-layer decoder, but it would be appreciated that the decoding operations may similarly be employed in a single-layer decoder.

The video decoder 550 comprises a first decoder section 552 for base view components and a second decoder section 554 for non-base view components. Block 556 illustrates a demultiplexer for delivering information regarding base view components to the first decoder section 552 and for delivering information regarding non-base view components to the second decoder section 554. Reference P′n stands for a predicted representation of an image block. Reference D′n stands for a reconstructed prediction error signal. Blocks 704, 804 illustrate preliminary reconstructed images (I′n). Reference R′n stands for a final reconstructed image. Blocks 703, 803 illustrate inverse transform (T⁻¹). Blocks 702, 802 illustrate inverse quantization (Q⁻¹). Blocks 701, 801 illustrate entropy decoding (E⁻¹). Blocks 705, 805 illustrate a reference frame memory (RFM). Blocks 706, 806 illustrate prediction (P) (either inter prediction or intra prediction). Blocks 707, 807 illustrate filtering (F). Blocks 708, 808 may be used to combine decoded prediction error information with predicted base view/non-base view components to obtain the preliminary reconstructed images (I′ n). Preliminary reconstructed and filtered base view images may be output 709 from the first decoder section 552 and preliminary reconstructed and filtered base view images may be output 809 from the first decoder section 554.

Herein, the decoder should be interpreted to cover any operational unit capable to carry out the decoding operations, such as a player, a receiver, a gateway, a demultiplexer and/or a decoder.

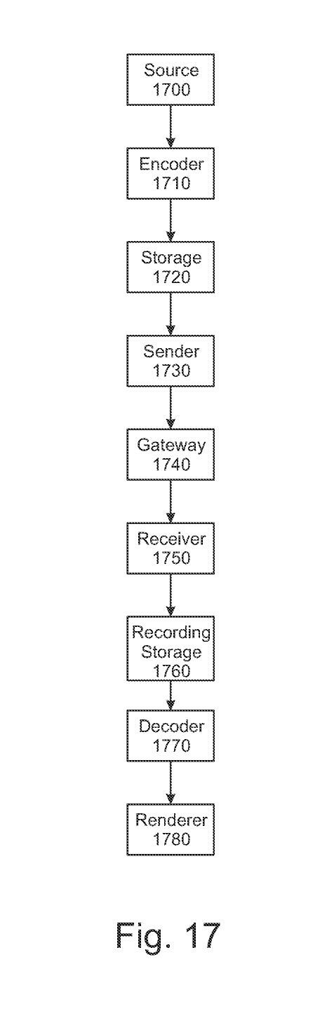

FIG. 17 is a graphical representation of an example multimedia communication system within which various embodiments may be implemented. A data source 1700 provides a source signal in an analog, uncompressed digital, or compressed digital format, or any combination of these formats. An encoder 1710 may include or be connected with a pre-processing, such as data format conversion and/or filtering of the source signal. The encoder 1710 encodes the source signal into a coded media bitstream. It should be noted that a bitstream to be decoded may be received directly or indirectly from a remote device located within virtually any type of network. Additionally, the bitstream may be received from local hardware or software. The encoder 1710 may be capable of encoding more than one media type, such as audio and video, or more than one encoder 1710 may be required to code different media types of the source signal. The encoder 1710 may also get synthetically produced input, such as graphics and text, or it may be capable of producing coded bitstreams of synthetic media. In the following, only processing of one coded media bitstream of one media type is considered to simplify the description. It should be noted, however, that typically real-time broadcast services comprise several streams (typically at least one audio, video and text sub-titling stream). It should also be noted that the system may include many encoders, but in the figure only one encoder 1710 is represented to simplify the description without a lack of generality. It should be further understood that, although text and examples contained herein may specifically describe an encoding process, one skilled in the art would understand that the same concepts and principles also apply to the corresponding decoding process and vice versa.

The coded media bitstream may be transferred to a storage 1720. The storage 1720 may comprise any type of mass memory to store the coded media bitstream. The format of the coded media bitstream in the storage 1720 may be an elementary self-contained bitstream format, or one or more coded media bitstreams may be encapsulated into a container file. If one or more media bitstreams are encapsulated in a container file, a file generator (not shown in the figure) may be used to store the one more media bitstreams in the file and create file format metadata, which may also be stored in the file. The encoder 1710 or the storage 1720 may comprise the file generator, or the file generator is operationally attached to either the encoder 1710 or the storage 1720. Some systems operate “live”, i.e. omit storage and transfer coded media bitstream from the encoder 1710 directly to the sender 1730. The coded media bitstream may then be transferred to the sender 1730, also referred to as the server, on a need basis. The format used in the transmission may be an elementary self-contained bitstream format, a packet stream format, or one or more coded media bitstreams may be encapsulated into a container file. The encoder 1710, the storage 1720, and the sender 1730 may reside in the same physical device or they may be included in separate devices. The encoder 1710 and sender 1730 may operate with live real-time content, in which case the coded media bitstream is typically not stored permanently, but rather buffered for small periods of time in the content encoder 1710 and/or in the sender 1730 to smooth out variations in processing delay, transfer delay, and coded media bitrate.

The sender 1730 sends the coded media bitstream using a communication protocol stack. The stack may include but is not limited to one or more of Real-Time Transport Protocol (RTP), User Datagram Protocol (UDP), Hypertext Transfer Protocol (HTTP), Transmission Control Protocol (TCP), and Internet Protocol (IP). The sender may comprise or be operationally attached to a packetizer (not shown in the figure). When the communication protocol stack is packet-oriented, the sender 1730 or the packetizer encapsulates the coded media bitstream into packets. For example, when RTP is used, the sender 1730 or the packetizer encapsulates the coded media bitstream into RTP packets according to an RTP payload format. Typically, each media type has a dedicated RTP payload format. It should be again noted that a system may contain more than one sender 1730, but for the sake of simplicity, the following description only considers one sender 1730. Similarly, the system may contain more than one packetizer.

If the media content is encapsulated in a container file for the storage 1720 or for inputting the data to the sender 1730, the sender 1730 may comprise or be operationally attached to a “sending file parser” (not shown in the figure). In particular, if the container file is not transmitted as such but at least one of the contained coded media bitstream is encapsulated for transport over a communication protocol, a sending file parser locates appropriate parts of the coded media bitstream to be conveyed over the communication protocol. The sending file parser may also help in creating the correct format for the communication protocol, such as packet headers and payloads. The multimedia container file may contain encapsulation instructions, such as hint tracks in the ISO Base Media File Format, for encapsulation of the at least one of the contained media bitstream on the communication protocol.

The sender 1730 may or may not be connected to a gateway 1740 through a communication network. The gateway may also or alternatively be referred to as a middle-box. It is noted that the system may generally comprise any number gateways or alike, but for the sake of simplicity, the following description only considers one gateway 1740. The gateway 1740 may perform different types of functions, such as translation of a packet stream according to one communication protocol stack to another communication protocol stack, merging and forking of data streams, and manipulation of data stream according to the downlink and/or receiver capabilities, such as controlling the bit rate of the forwarded stream according to prevailing downlink network conditions. Examples of gateways 1740 include multipoint conference control units (MCUs), gateways between circuit-switched and packet-switched video telephony, Push-to-talk over Cellular (PoC) servers, IP encapsulators in digital video broadcasting-handheld (DVB-H) systems, or set-top boxes or other devices that forward broadcast transmissions locally to home wireless networks. When RTP is used, the gateway 1740 may be called an RTP mixer or an RTP translator and may act as an endpoint of an RTP connection. Instead of or in addition to the gateway 1740, the system may include a splicer which concatenates video sequence or bitstreams.

The system includes one or more receivers 1750, typically capable of receiving, de-modulating, and de-capsulating the transmitted signal into a coded media bitstream. The receiver 1750 may comprise or be operationally attached with a depacketizer, which de-capsulates media data from the payloads of the packets of the communication protocol in use. The coded media bitstream may be transferred to a recording storage 1760. The recording storage 1760 may comprise any type of mass memory to store the coded media bitstream. The recording storage 1760 may alternatively or additively comprise computation memory, such as random access memory. The format of the coded media bitstream in the recording storage 1760 may be an elementary self-contained bitstream format, or one or more coded media bitstreams may be encapsulated into a container file. If there are multiple coded media bitstreams, such as an audio stream and a video stream, associated with each other, a container file is typically used and the receiver 1750 comprises or is attached to a container file generator producing a container file from input streams. Some systems operate “live,” i.e. omit the recording storage 1760 and transfer coded media bitstream from the receiver 1750 directly to the decoder 1770. In some systems, only the most recent part of the recorded stream, e.g., the most recent 10-minute excerption of the recorded stream, is maintained in the recording storage 1760, while any earlier recorded data is discarded from the recording storage 1760.

The coded media bitstream may be transferred from the recording storage 1760 to the decoder 1770. If there are many coded media bitstreams, such as an audio stream and a video stream, associated with each other and encapsulated into a container file or a single media bitstream is encapsulated in a container file e.g. for easier access, a file parser (not shown in the figure) is used to decapsulate each coded media bitstream from the container file. The recording storage 1760 or a decoder 1770 may comprise the file parser, or the file parser is attached to either recording storage 1760 or the decoder 1770. It should also be noted that the system may include many decoders, but here only one decoder 1770 is discussed to simplify the description without a lack of generality

The coded media bitstream may be processed further by a decoder 1770, whose output is one or more uncompressed media streams. Finally, a renderer 1780 may reproduce the uncompressed media streams with a loudspeaker or a display, for example. The receiver 1750, recording storage 1760, decoder 1770, and renderer 1780 may reside in the same physical device or they may be included in separate devices.

In the above, where the example embodiments have been described with reference to an encoder, it needs to be understood that the resulting bitstream and the decoder may have corresponding elements in them. Likewise, where the example embodiments have been described with reference to a decoder, it needs to be understood that the encoder may have structure and/or computer program for generating the bitstream to be decoded by the decoder.

The embodiments of the invention described above describe the codec in terms of separate encoder and decoder apparatus in order to assist the understanding of the processes involved. However, it would be appreciated that the apparatus, structures and operations may be implemented as a single encoder-decoder apparatus/structure/operation. Furthermore, it is possible that the coder and decoder may share some or all common elements.

Although the above examples describe embodiments of the invention operating within a codec within an electronic device, it would be appreciated that the invention as defined in the claims may be implemented as part of any video codec. Thus, for example, embodiments of the invention may be implemented in a video codec which may implement video coding over fixed or wired communication paths.

Thus, user equipment may comprise a video codec such as those described in embodiments of the invention above. It shall be appreciated that the term user equipment is intended to cover any suitable type of wireless user equipment, such as mobile telephones, portable data processing devices or portable web browsers.

Furthermore elements of a public land mobile network (PLMN) may also comprise video codecs as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of the claims.

1. A method comprising:
encoding a first scalability layer comprising at least a first coded base picture and a second coded base picture, the first scalability layer being decodable using a first algorithm;
reconstructing the first and second coded base pictures into a first and second reconstructed base pictures, respectively, the first reconstructed base picture and the second reconstructed base picture being adjacent in output order of the first algorithm among all reconstructed pictures of the first scalability layer;
reconstructing, by using a second algorithm, a third reconstructed base picture from at least the first and second reconstructed base pictures, the third reconstructed base picture residing between the first reconstructed base picture and the second reconstructed base picture in output order;
encoding a second scalability layer comprising at least a first coded enhancement picture, a second coded enhancement picture and a third coded enhancement picture, the second scalability layer being decodable using a third algorithm comprising inter-layer prediction that takes a reconstructed picture as input; and
reconstructing the first, second, and third coded enhancement pictures into a first, second, and third reconstructed enhancement pictures, respectively, by giving the first, second, and third reconstructed base pictures, respectively, as input for inter-layer prediction, the first, second, and third reconstructed enhancement picture matching in output order of the first algorithm with the first, second, and third reconstructed base pictures, respectively.

2. The method according to claim 1, further comprising:
indicating that the first coded base picture and the second coded base picture conform to a first profile;
indicating a second profile that is required to reconstruct the third reconstructed base picture;
indicating that the first coded enhancement picture, the second coded enhancement picture, and the third coded enhancement picture conform to a third profile;
wherein the first profile, the second profile, and the third profile differ from each other and the first profile is indicative of the first algorithm; the second profile is indicative of the second algorithm, and the third profile is indicative of the third algorithm.

3. The method according to claim 1, wherein the picture rate is increased without enhancing the base pictures in the first scalability layer, the method further comprising at least one of the following:
encoding the second scalability layer in a manner that the pictures corresponding to the pictures of the first scalability layer are skip coded;
encoding the second scalability layer in a manner that no pictures are encoded corresponding to the pictures of the first scalability layer.

4. The method according to claim 1, the method further comprising at least one of the following:
reconstructing the third reconstructed base picture from at least the first and second reconstructed base pictures prior to their modification; and modifying the first, second and third reconstructed base pictures by using the corresponding pictures of the second enhancement layer;
modifying the first and second reconstructed base pictures, and using the modified first and second base pictures as input to reconstruct the third reconstructed base picture;
modifying the first and second reconstructed base pictures by using the corresponding pictures of the second enhancement layer, and using the reconstructed pictures of the second enhancement layer as input to reconstruct the third reconstructed base picture.

5. The method according to claim 1, wherein the picture rate is increased and at least one type of enhancement is applied to the base pictures of the first scalability layer, the enhancement comprising at least one of the following: signal-to-noise enhancement, spatial enhancement, sample bit-depth increase, dynamic range increase, or broadening the color gamut.

6. An apparatus comprising:
at least one processor and at least one memory, said at least one memory stored with code thereon, which when executed by said at least one processor, causes an apparatus to perform at least
encoding a first scalability layer comprising at least a first coded base picture and a second coded base picture, the first scalability layer being decodable using a first algorithm;
reconstructing the first and second coded base pictures into a first and second reconstructed base pictures, respectively, the first reconstructed base picture and the second reconstructed base picture being adjacent in output order of the first algorithm among all reconstructed pictures of the first scalability layer;
reconstructing, by using a second algorithm, a third reconstructed base picture from at least the first and second reconstructed base pictures, the third reconstructed base picture residing between the first reconstructed base picture and the second reconstructed base picture in output order;
encoding a second scalability layer comprising at least a first coded enhancement picture, a second coded enhancement picture and a third coded enhancement picture, the second scalability layer being decodable using a third algorithm comprising inter-layer prediction that takes a reconstructed picture as input; and
reconstructing the first, second, and third coded enhancement pictures into a first, second, and third reconstructed enhancement pictures, respectively, by giving the first, second, and third reconstructed base pictures, respectively, as input for inter-layer prediction, the first, second, and third reconstructed enhancement picture matching in output order of the first algorithm with the first, second, and third reconstructed base pictures, respectively.

7. The apparatus according to claim 6, the apparatus further comprising code causing the apparatus to perform at least one of the following: indicating that the first coded base picture and the second coded base picture conform to a first profile;
indicating a second profile that is required to reconstruct the third reconstructed base picture;
indicating that the first coded enhancement picture, the second coded enhancement picture, and the third coded enhancement picture conform to a third profile;
wherein the first profile, the second profile, and the third profile differ from each other and the first profile is indicative of the first algorithm; the second profile is indicative of the second algorithm, and the third profile is indicative of the third algorithm.

8. The apparatus according to claim 6, wherein the apparatus is configured to increase the picture rate without enhancing the base pictures in the first scalability layer, the apparatus further comprising code causing the apparatus to perform at least one of the following:
encoding the second scalability layer in a manner that the pictures corresponding to the pictures of the first scalability layer are skip coded;
encoding the second scalability layer in a manner that no pictures are encoded corresponding to the pictures of the first scalability layer.

9. The apparatus according to claim 6, wherein the apparatus further comprises code causing the apparatus to perform at least one of the following:
reconstructing the third reconstructed base picture from at least the first and second reconstructed base pictures prior to their modification; and modifying the first, second and third reconstructed base pictures by using the corresponding pictures of the second enhancement layer;
modifying the first and second reconstructed base pictures, and using the modified first and second base pictures as input to reconstruct the third reconstructed base picture;
modifying the first and second reconstructed base pictures by using the corresponding pictures of the second enhancement layer, and using the reconstructed pictures of the second enhancement layer as input to reconstruct the third reconstructed base picture.

10. The apparatus according to claim 6, wherein the picture rate is increased and at least one type of enhancement is applied to the base pictures of the first scalability layer, the enhancement comprising at least one of the following: signal-to-noise enhancement, spatial enhancement, sample bit-depth increase, dynamic range increase, or broadening the color gamut.

11. A method comprising:
decoding, using a first algorithm, a first and a second coded base pictures into a first and a second reconstructed base pictures, respectively, the first and second coded base pictures being comprised in a first scalability layer and the first reconstructed base picture and the second reconstructed base picture being adjacent in output order of the first algorithm among all reconstructed pictures of the first scalability layer;
reconstructing, by using a second algorithm, a third reconstructed base picture from at least the first and second reconstructed base pictures, the third reconstructed base picture residing between the first reconstructed base picture and the second reconstructed base picture in output order; and
decoding, using a third algorithm, a first, a second, and a third coded enhancement pictures into a first, a second, and a third reconstructed enhancement pictures, respectively, by giving the first, second, and third reconstructed base pictures, respectively, as input for inter-layer prediction, the third algorithm comprising inter-layer prediction that takes a reconstructed picture as input, the first, second, and third reconstructed enhancement picture matching in output order of the first algorithm with the first, second, and third reconstructed base pictures, respectively, and the first, second and third coded enhancement pictures being comprised in a second scalability layer.

12. The method according to claim 11, further comprising:
decoding a first indication that the first coded base picture and the second coded base picture conform to a first profile;
decoding a second indication of a second profile that is required to reconstruct the third reconstructed base picture;
decoding a third indication that the first coded enhancement picture, the second coded enhancement picture, and the third coded enhancement picture conform to a third profile;
wherein the first profile, the second profile, and the third profile differ from each other and the first profile is indicative of the first algorithm; the second profile is indicative of the second algorithm, and the third profile is indicative of the third algorithm; and
determining on the decoding of the first and second coded base pictures on the basis of supporting the first profile in decoding;
determining on the reconstructing of the third reconstructed base pictures on the basis of supporting the second profile in reconstructing and the first profile in decoding;
determining on the decoding of the first and second coded enhancement pictures on the basis of supporting the first and third profiles in decoding; and
determining on the decoding of the third enhancement picture on the basis of supporting the first and third profiles in decoding and the second profile in reconstructing.

13. The method according to claim 11, wherein the picture rate is increased without enhancing the base pictures in the first scalability layer, the method further comprising at least one of the following:
decoding an indication associated with the second scalability layer indicating that the pictures corresponding to the pictures of the first scalability layer are skip coded;
decodes the second scalability layer in a manner that no pictures are decoded corresponding to the pictures of the first scalability layer.

14. The method according to claim 11, the method further comprising at least one of the following:
reconstructing the third reconstructed base picture from at least the first and second reconstructed base pictures prior to their modification; and modifying the first, second and third reconstructed base pictures by using the corresponding pictures of the second enhancement layer;
modifying the first and second reconstructed base pictures, and using the modified first and second base pictures as input to reconstruct the third reconstructed base picture;
modifying the first and second reconstructed base pictures by using the corresponding pictures of the second enhancement layer, and using the reconstructed pictures of the second enhancement layer as input to reconstruct the third reconstructed base picture.

15. The method according to claim 11, wherein the picture rate is increased and at least one type of enhancement is applied to the base pictures of the first scalability layer, the enhancement comprising at least one of the following: signal-to-noise enhancement, spatial enhancement, sample bit-depth increase, dynamic range increase, or broadening the color gamut.

16. An apparatus comprising:
at least one processor and at least one memory, said at least one memory stored with code thereon, which when executed by said at least one processor, causes an apparatus to perform at least
decoding, using a first algorithm, a first and a second coded base pictures into a first and a second reconstructed base pictures, respectively, the first and second coded base pictures being comprised in a first scalability layer and the first reconstructed base picture and the second reconstructed base picture being adjacent in output order of the first algorithm among all reconstructed pictures of the first scalability layer;
reconstructing, by using a second algorithm, a third reconstructed base picture from at least the first and second reconstructed base pictures, the third reconstructed base picture residing between the first reconstructed base picture and the second reconstructed base picture in output order; and
decoding, using a third algorithm, a first, a second, and a third coded enhancement pictures into a first, a second, and a third reconstructed enhancement pictures, respectively, by giving the first, second, and third reconstructed base pictures, respectively, as input for inter-layer prediction, the third algorithm comprising inter-layer prediction that takes a reconstructed picture as input, the first, second, and third reconstructed enhancement picture matching in output order of the first algorithm with the first, second, and third reconstructed base pictures, respectively, and the first, second and third coded enhancement pictures being comprised in a second scalability layer.

17. The apparatus according to claim 16, wherein the apparatus further comprises code causing the apparatus to perform:
decoding a first indication that the first coded base picture and the second coded base picture conform to a first profile;
decoding a second indication of a second profile that is required to reconstruct the third reconstructed base picture;
decoding a third indication that the first coded enhancement picture, the second coded enhancement picture, and the third coded enhancement picture conform to a third profile;
wherein the first profile, the second profile, and the third profile differ from each other and the first profile is indicative of the first algorithm; the second profile is indicative of the second algorithm, and the third profile is indicative of the third algorithm; and
determining on the decoding of the first and second coded base pictures on the basis of supporting the first profile in decoding;
determining on the reconstructing of the third reconstructed base pictures on the basis of supporting the second profile in reconstructing and the first profile in decoding;
determining on the decoding of the first and second coded enhancement pictures on the basis of supporting the first and third profiles in decoding; and
determining on the decoding of the third enhancement picture on the basis of supporting the first and third profiles in decoding and the second profile in reconstructing.

18. The apparatus according to claim 16, wherein the apparatus is configured to increase the picture rate without enhancing the base pictures in the first scalability layer, the apparatus further comprising code causing the apparatus to perform at least one of the following:
decoding an indication associated with the second scalability layer indicating that the pictures corresponding to the pictures of the first scalability layer are skip coded;
decoding the second scalability layer in a manner that no pictures are decoded corresponding to the pictures of the first scalability layer.

19. The apparatus according to claim 16, wherein the apparatus further comprises code causing the apparatus to perform at least one of the following:
reconstructing the third reconstructed base picture from at least the first and second reconstructed base pictures prior to their modification; and modifying the first, second and third reconstructed base pictures by using the corresponding pictures of the second enhancement layer;
modifying the first and second reconstructed base pictures, and using the modified first and second base pictures as input to reconstruct the third reconstructed base picture;
modifying the first and second reconstructed base pictures by using the corresponding pictures of the second enhancement layer, and using the reconstructed pictures of the second enhancement layer as input to reconstruct the third reconstructed base picture.

20. The apparatus according to claim 16, wherein the picture rate is increased and at least one type of enhancement is applied to the base pictures of the first scalability layer, the enhancement comprising at least one of the following: signal-to-noise enhancement, spatial enhancement, sample bit-depth increase, dynamic range increase, or broadening the color gamut.
